(19) United States
(12) Patent Application Publication
(10) Pub. No.: US 2026/0136070 A1
(43) Pub. Date: May 14, 2026

(54) SYSTEMS AND METHODS FOR ACTION-BASED SPLIT-SCREEN VIDEO GENERATION

(71) Applicant: Adeia Guides Inc., San Jose, CA (US)

(72) Inventors: Jean-Yves Couleaud, Mission Viejo, CA (US); Evgeny Kaminsky, Hollywood, FL (US); Charles Dasher, Lawrenceville, GA (US); Tao Chen, Palo Alto, CA (US); Ning Xu, Irvine, CA (US)

(21) Appl. No.: 18/942,922

(22) Filed: Nov. 11, 2024

(51) Int. Cl. H04N 21/472; G06F 16/71; G06F 16/732; G06V 20/40; H04N 21/431

(52) U.S. Cl. CPC H04N 21/47205; G06F 16/71; G06F 16/7328; G06V 20/46; G06V 20/49; H04N 21/4312

(57) ABSTRACT

Methods and systems are described herein for efficient video-to-video search and composite video generation. In an example system, the system receives a video, via a user device, and extracts action embeddings and pose embeddings. The system identifies a first subset of videos based on the extracted action embeddings. The system identifies a second subset of videos from the first subset of videos based on the extracted pose embeddings. The system receives a selection of a video from the second subset of videos. The system generates for display a composite video comprising the first video and the selected video.

### BACKGROUND

This disclosure relates to systems and methods for generating content. More specifically, this disclosure relates to systems and methods for generating videos using video-to-video search.

### SUMMARY

Creating and editing multimedia content is difficult enough, but identifying and/or syncing content segments to generate split-screen content can often require more than double the time and computing resources. Split-screen videos in social media are typically short-form videos where a creator places their video next to an existing video to create a composite video for entertainment purposes. In some creations, the videos are linked by the action of the existing video. For example, a split-screen video may be made of two videos representing the same or similar action but performed by different people or in different settings. In this case, a video may display a subject mimicking a viral dance scene from a television show. In another example, a split-screen video may be made of two halves shot at separate times with different people. In this case, a creator may display a half-bodied video of a person to pair with the opposing half-bodied video of a viral dance scene from a well-known video clip. In some cases, these split-screen videos are created as memes.

In some cases, the creator may start with an existing video and add their version to the original video to create the split-screen effect. However, in other cases, the creator may know a viral dance they want to enact, but not know (or cannot find) a source of the dance. The creator would then have a limited ability to generate a split-screen video. There is a lack of methods today for a creator to generate a video depicting an action and find an existing video depicting the same action to generate a split-screen video.

In one approach, advanced computer vision techniques, such as deep learning models, may be implemented to analyze and compare the visual and sometimes audio content of videos to compile a video-to-video search rather than text-based keywords or metadata. By extracting features like objects, scenes, and actions, these systems may find similar or related videos across libraries of content. This technology is particularly useful in fields where visual information is more important than text, for example, where users may want to find products shown in a video or similar content (e.g., surveillance, media and entertainment, and e-commerce). These models may be used for advanced human action detection capable of learning spatial features from video frames. In some cases, techniques, such as 2D convolution neural networks (CNNs) applied frame by frame and 3D CNNs, which capture both spatial and temporal information, have been used for advanced human action detection. In other approaches, action detection models may include recurrent neural networks (RNNs) and long short-term memory (LSTMs) to improve the handling of temporal sequences. These RNNs may be designed to remember previous frames, incorporating the temporal dependencies across a video, and improving the detection of sequential actions. Some approaches leverage transformer architectures and have shown promise in understanding dependencies in video sequences, thus providing a more holistic understanding of actions. However, using a deep learning model for video-to-video search may have significant model complexity and storage volumes that limit scalability of this approach. This approach requires high energy consumption, expensive hardware, and skilled labor to train, optimize, and fine-tune the deep learning models. In addition, deep learning models may be limited by the lack of diversity represented in the training data set provided; therefore, the model may be potentially limited or biased in providing search results.

In another approach, human action detection may be used to identify and/or classify specific actions performed by individuals in video footage. For example, this technique may be used in surveillance, sports analytics, human-computer interaction, and video content analysis. Human action detection may include specialized methods such as histograms of oriented gradients (HOG), histograms of optical flow (HOF), and scale-invariant feature transform (SIFT). These methods may involve tracking body parts or using motion history images (e.g., a technique that captures the dynamics of actions performed over time) to detect actions. However, these approaches are limited by their reliance on manual feature selection and often struggle with complex scenes (e.g., scenes with a non-stationary background and/or occlusions).

The video-to-video search approaches discussed above may also provide search results lacking relevance due to being limited to a reduced set of actions that generalize a video. For example, a video of someone dancing the waltz and a video of someone performing acrobatic rock and roll may both be categorized as “a person dancing” despite the dance categories being distinct. In another example, a video of someone baking a cake and a video of someone tossing a salad may both be action-classified as “someone preparing food.” However, adjusting these limits to detect and match micro-actions within a video without context may further contribute to the computational and scalability limitations discussed above.

While the approaches above may provide a limited means for video-to-video search, they rely on the creator to download a search result, upload both the input video and selected video to another application for adjusting, configuring, captioning, adding effects, and/or any other desirable changes or any combination thereof to make a finalized split-screen video prior to publishing on a desired media platform.

Accordingly, there is a need to provide an efficient contextual video-to-video search based on the actions detected within the videos to create composite videos. Such a solution may differentiate between micro- and/or sub-actions within a detected action to return relevant search results when matching one video to another. Generally, this may be particularly advantageous when the videos being compared have different lengths or contain additional differing actions. Using two stages for comparing actions may be more efficient with time and computing resources than, e.g., relying on either stage alone in a comparison to candidate search results. Such a solution may couple a method to extract a general context (e.g., “dancing” or “preparing food”) with a method to extract a set of action qualifiers or sub-actions allowing for a better matching of one video with another. For example, the method may include actions and sub-actions stored in a nested structure to allow a search engine to perform more quickly and at a lower computational cost by first searching for a high-level action then searching the first results for a pose-based action. With contextually relevant search results, the media platform may automatically generate a composite split-screen video without the user having to export the video files to other applications for alterations, configurations, captioning, or effects. Systems and methods are provided herein for action-based split-screen video generation.

In some embodiments, the media platform may perform an efficient video-to-video search using a two-stage action identification model by first searching for a first subset of videos using a main action and then searching the first subset of videos for a second subset of videos using subclasses of the main action. For example, the media platform may receive a first video (e.g., as input or otherwise identified or selected) depicting a person dancing with several different rapid, high-amplitude movements, where the action may be classified as a person dancing and the micro-action may be identified as the distinct rapid, high-amplitude movements. The media platform may normalize the first video to a set of unique characteristics (e.g., resolution, color grading, frame rate, etc.). The media platform may use an action recognition model (also referred herein as “action identification model,” and “action encoder”) to produce a series of action embeddings and a pose estimation model (also referred herein as “pose encoder”) to produce a series of pose embeddings nested for action embeddings. An action embedding (also referred to as an action encoding) may be represented by, for example, rational, floating point, and/or irrational numbers in a vector, matrix, tensor, etc. For instance, an action embedding may be a 100×100 square matrix. Similarly, a pose embedding (also referred to as a pose encoding) may be represented by, for example, rational. floating point, and/or irrational numbers in a vector, matrix, tensor, etc. For instance, a pose embedding may be a 50-component vector. The action embeddings and/or pose embeddings may be stored, e.g., in a data structure, database, metadata, or other similar modality. The media platform may use a similarity function that compares the action embeddings generated for a portion of the first video with the action embeddings generated for a portion of the videos of a video database. In this example, the first stage of the two-stage identification model may return a subset of videos containing content with action embeddings containing “person dancing,” thus providing a subset of videos containing a single person dancing. For example, the first subset may include several types of dancing but not necessarily be limited to dances with rapid, high-amplitude movements. The media platform may then use a similarity function that compares pose embeddings generated for the identified actions with the pose embeddings generated for the identified actions of the subset of videos output from the action embedding comparison. In this example, the second stage of the two-stage identification model may return a second subset of videos from the first subset of videos containing content with pose embeddings containing rapid, high-amplitude movements. For example, the videos in the second subset generated for display by the media platform may include videos of people dancing with rapid, high-amplitude movements, e.g., Stephen “Twitch” Boss, a freestyle hip hop dancer and/or Wednesday Addams, a character from a viral dance scene from the television program “Wednesday.” The platform may then receive a selection of the Wednesday Addams video and generate a composite video for display where the user input video is displayed in the top half of the device display area and the Wednesday Addams video is in the bottom half of the display area.

In some embodiments, pose embeddings may be leveraged to create various formats of split video display. For example, the pose embeddings may be used to determine movements of an upper portion of the first video that correspond with movements of a lower portion of the selected video and generate a composite video of the top portion of the first video in the upper portion of the display area and a bottom portion of the selected video in the bottom portion of the display area. Using the Wednesday Addams video, for example, the video may display the creator's head, arms, and torso, and Wednesday Addams' hips, legs, and feet. In another example, the pose embeddings may be used to determine joint clusters that may be used to create polygonal split-screen sections for the first video and for the selected video and generate a composite video of respective polygonal split-screen sections of the first video and respective polygonal split-screen sections of the selected video distributed within polygonal split-screen sections of a display area. Using the Wednesday Addams video, for example, the video may display the creator's head, torso, and legs, and Wednesday Addams' arms, hips, and feet. For example, the media platform may receive user input to alternate between the first video and the selected video at the location of the input.

Using the methods described herein, the media platform provides an efficient method for video-to-video search and generation of composite split-screen videos.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1 depicts a schematic illustration of video-to-video searching and generation of composite split-screen videos, in accordance with some embodiments of the disclosure.

FIG. 2A depicts a schematic illustration of a composite split-screen video, in accordance with some embodiments of the disclosure.

FIG. 2B depicts a schematic illustration of a composite split-screen video, in accordance with some embodiments of the disclosure.

FIG. 3 depicts a schematic illustration of generating action embeddings, in accordance with some embodiments of the disclosure.

FIG. 4 depicts a schematic illustration of generating action embeddings and pose embeddings, in accordance with some embodiments of the disclosure.

FIG. 5 depicts a schematic illustration of pose embeddings nested within action embeddings.

FIG. 6 depicts a flowchart of a process for generating and storing action and pose embeddings, in accordance with some embodiments of the disclosure.

FIG. 7 depicts a schematic illustration of reformatting pose data for computation, in accordance with some embodiments of the disclosure.

FIG. 8 depicts a flowchart of a process for video selection based on action and pose embeddings, in accordance with some embodiments of the disclosure.

FIG. 9 depicts a flowchart of a process for video alteration based on pose similarity score, in accordance with some embodiments of the disclosure.

FIG. 10 depicts a schematic illustration of polygonal split-screen video generation, in accordance with some embodiments of the disclosure.

FIG. 11 depicts illustrative user equipment, in accordance with some embodiments of the disclosure.

FIG. 12 depicts an illustrative user equipment system, in accordance with some embodiments of the disclosure.

The drawings are intended to depict only typical aspects of the subject matter disclosed herein, and therefore should not be considered as limiting the scope of the disclosure. Those skilled in the art will understand that the structures, systems, devices, and methods specifically described herein and illustrated in the accompanying drawings are non-limiting embodiments and that the scope of the present invention is defined solely by the claims.

### DETAILED DESCRIPTION OF THE DRAWINGS

As referred to herein, the words and phrases “system,” “media platform,” “content application,” “interactive content guidance application,” and “media application” are used interchangeably. Interactive content guidance applications may take various forms, such as interactive program guides, electronic program guides and/or user interfaces, which may allow users to navigate among and locate many types of content including user-generated videos, conventional film and television programming (provided via broadcast, cable, fiber optics, satellite, internet (IPTV), or other means), and recorded programs (e.g., DVRs) as well as pay-per-view programs, on-demand programs (e.g., video-on-demand systems), internet content (e.g., streaming media, downloadable content, webcasts, social media content, etc.), music, audiobooks, websites, animations, podcasts, (video) blogs, eBooks, and/or other types of media and content.

Media applications may be implemented to find and/or discover content available through a device (e.g., a television), or through one or more devices, or bring together content available through a television and/or through internet-connected devices using interactive guidance. Content applications may be provided as online applications (e.g., provided on a website), or as stand-alone applications or clients on handheld computers, mobile phones, or other mobile devices. For instance, a social media platform may implement one or more media applications. Various devices and platforms that may implement content guidance applications are described in more detail below.

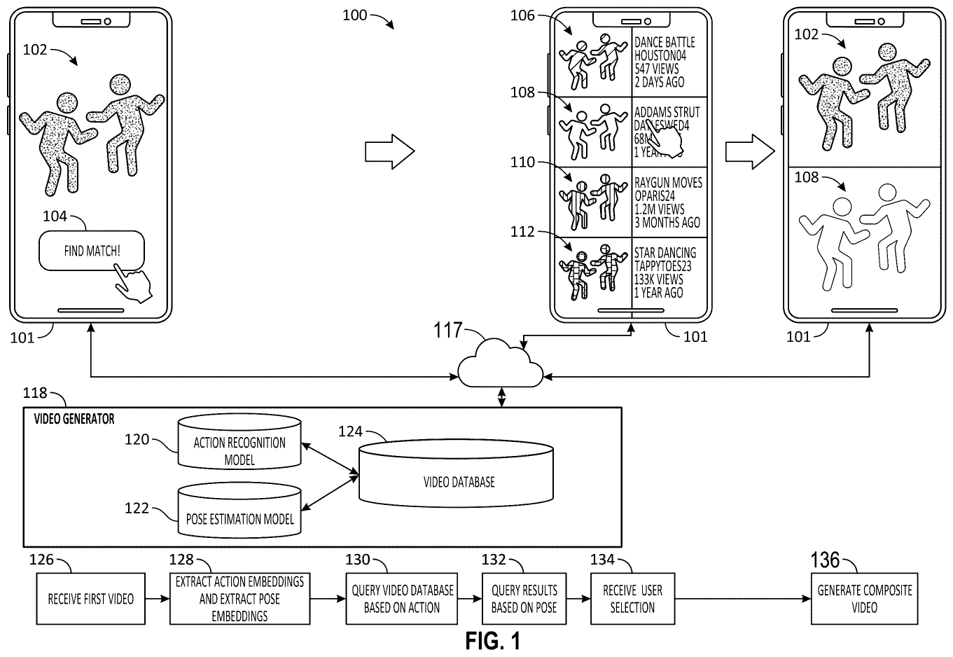

FIG. 1 depicts a schematic illustration of video-to-video searching and generation of composite split-screen videos, in accordance with some embodiments of the disclosure.

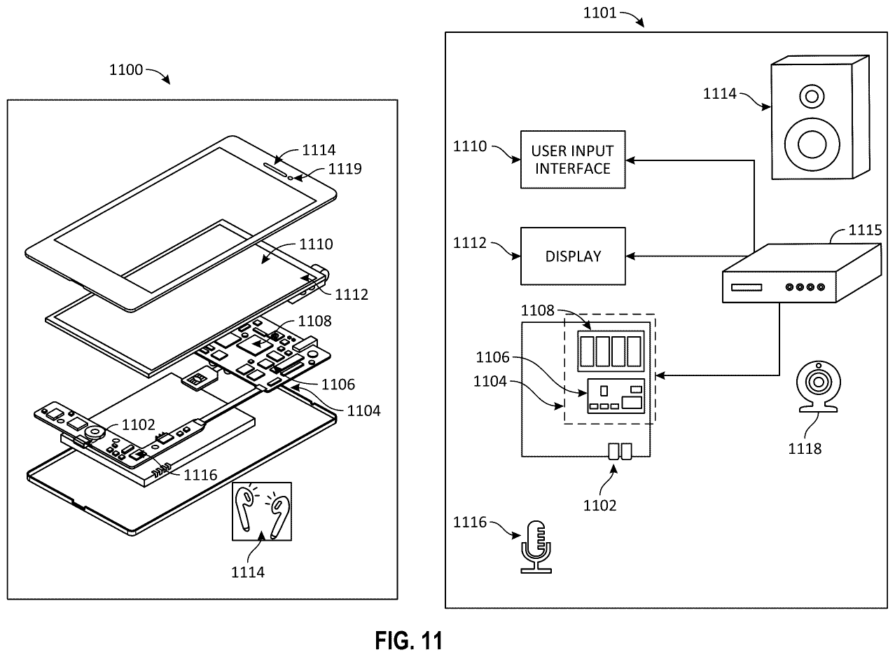

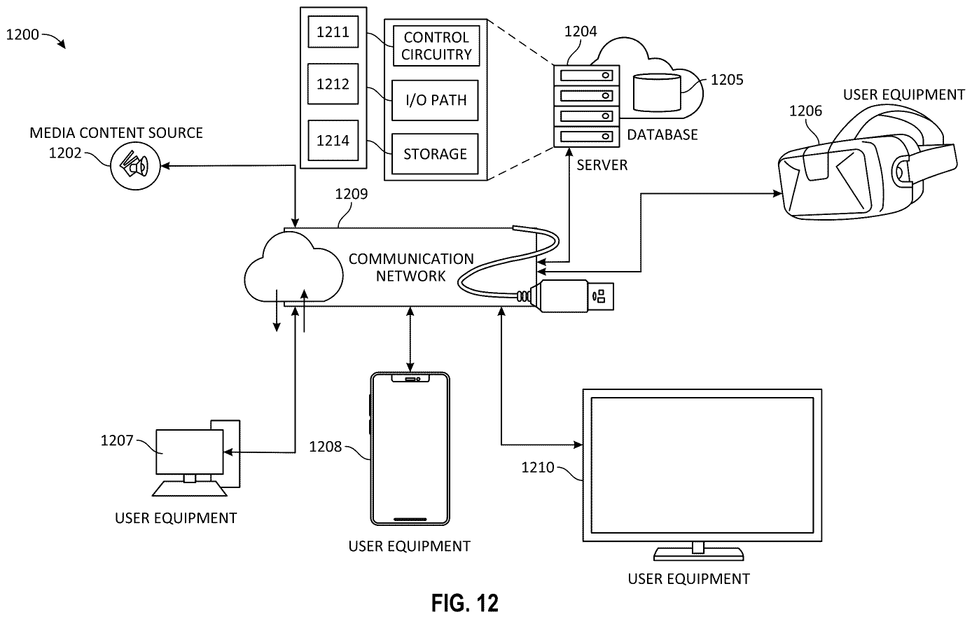

In some embodiments, at 126, video generator 118 may receive or otherwise identify video 102 via communication network 117. In some embodiments, video generator 118 may be a server, cloud server, mainframe, and/or any other suitable device or computing device, or any combination thereof. In some embodiments, the video is locally stored or generated by user device 101. For example, the media application may retrieve the video from storage circuitry (e.g., 1108 of FIG. 11, and 1214 of FIG. 12), or the media application may record the video in real time (e.g., through camera 1118 of FIG. 11). In some embodiments, the control circuitry, running the media application, may receive the video from an external source. For example, control circuitry, running the media application, may retrieve the video from a server (e.g., 1204 of FIG. 12), from other user equipment (e.g., 1206, 1207, 1208, and 1210 of FIG. 12), or from a storage device (e.g., CDs, DVDs, Blu-rays, USB drives, flash drives, NVMe, and NAS). In some embodiments, the server may be associated with streaming platforms (e.g., YouTube®, Netflix®, etc.), file-sharing or storage platforms, media applications, or other media content providers. In some embodiments, the video is requested and transmitted via a communication network (e.g., 117 or 1209 of FIG. 12) via a wireless or wired connection (e.g., input/output (I/O) path 1102 of FIG. 11 and I/O path 1212 of FIG. 12).

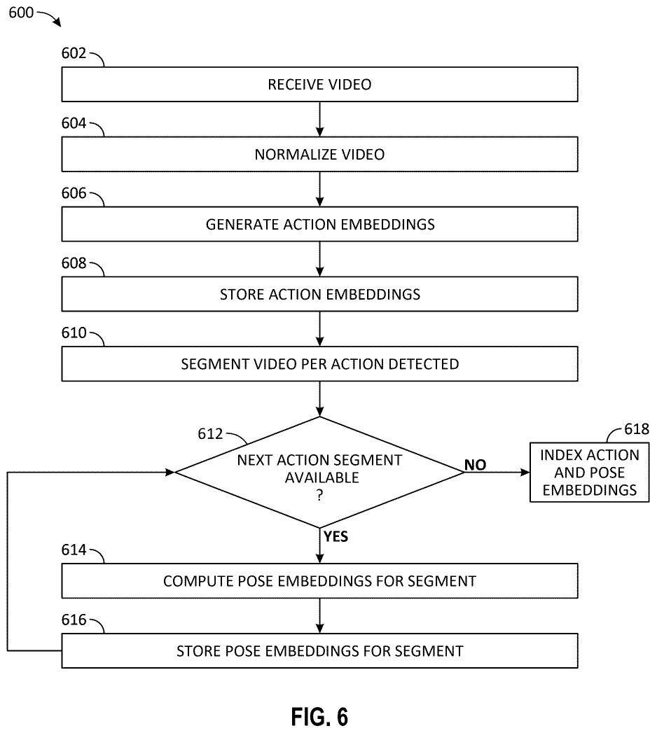

In some embodiments, the media application may receive user input 104 to initiate the video-to-video search. In some embodiments, the media application may receive user input to modify the query input. For example, the media application may receive user input to select only a portion of the video (e.g., whole body, body part, or body parts of a figure or figures in a video). In another example, the media application may automatically select a subset of the video identified as the most important action (e.g., based on motion, location, etc.). In some embodiments, the media application may search using cross-action matching. For example, the media application may query for a certain pose of an action in a first video that is the same pose but from a different identified action of a second video. In some embodiments, the media application may search using object identification. For example, the media application may identify an object in the video (e.g., a table a person is dancing on top of) and search for other videos with actions including a table. In some embodiments, the received video may require pre-processing such as normalization (e.g., as described in relation to 604 of FIG. 6) to a set of unique characteristics (e.g., resolution, color grading, frame rate, etc.), discussed in more detail below.

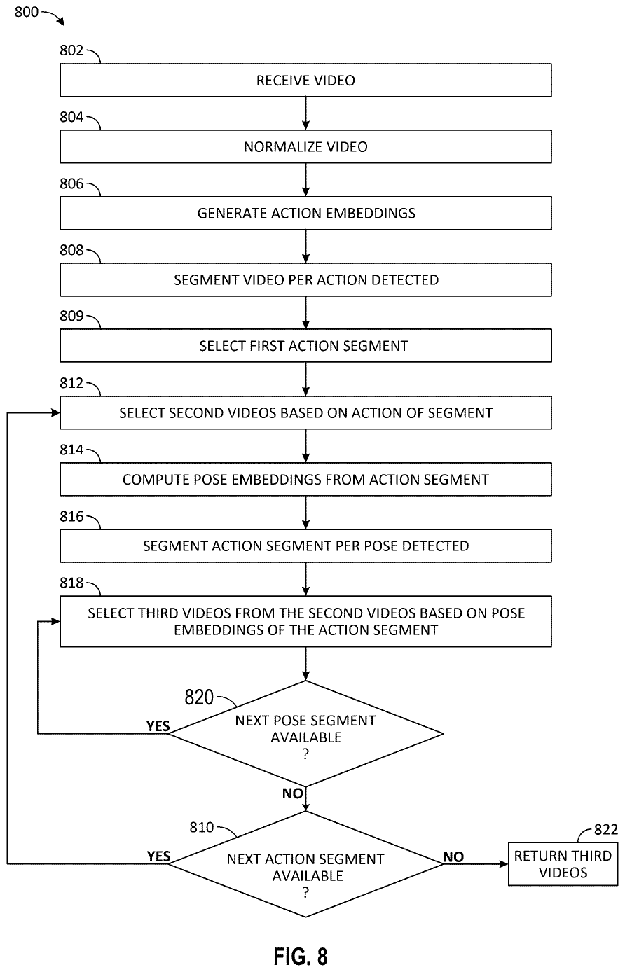

In some embodiments, at 128, video generator 118 may extract or generate action embeddings via the action recognition model 120 of the video generator 118 (e.g., as described in relation to 606 of FIG. 6). The action identification model 120 may perform using techniques such as spatiotemporal filtering, optical flow, histogram of oriented gradients (HOG), motion history images (MHI), space-time interest points (STIP), bag of visual words (BoVW), transformers, and/or one or more deep learning models (e.g., 2D or 3D convolutional neural network, recurrent neural network, long short-term memory, and graph neural networks). The extracted action embedding may be stored in an indexed data structure part of or linked to a database (e.g., as described in relation to 608 of FIG. 6), and as discussed in more detail below. In some embodiments, the video may be segmented per action detected (e.g., as described in relation to 808 of FIG. 8), discussed in more detail below.

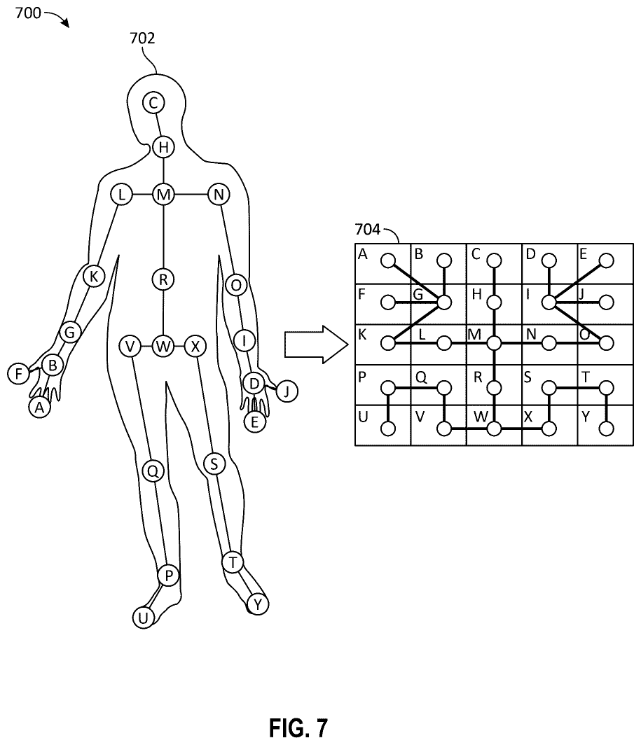

In some embodiments, at 128, video generator 118 may extract, generate, compute, or otherwise determine pose embeddings via the pose estimation model 122 of the video generator 118. For example, the pose estimation model may perform skeletal reconstruction by performing pose tracking to identify key joints and their connections over time. The pose estimation model may use a deep learning model (e.g., 2D or 3D convolutional neural network, recurrent neural network, long short-term memory, and graph neural network) to extract the underlying bone and joint structure of a person's body from the video frames (e.g., as illustratively represented by skeletal joints and connections A-Y of person 702 of FIG. 7). In some embodiments, the pose estimation model may extract features such as joint coordinates, angles between joints, joint motion, etc. In some embodiments, the pose estimation model may transform or format the pose data. For example, the media application may represent the pose estimation data as coordinates (x, y) and organize this data into a 2D matrix (e.g., 704 of FIG. 7). In some embodiments, the pose estimation model may output a representation of the pose data in the form of a pose embedding. In some embodiments, the action segment may be further segmented per pose detected (e.g., as described in relation to 816 of FIG. 8), discussed in more detail below.

In some embodiments, the system may utilize additional methods of action and pose detection to enhance a video search. In some embodiments, the system may implement contextual semantic analysis to analyze both the action and the surrounding context (e.g., environment, objects, and background interactions). For example, using this technique, the system may recognize that a player in a video is “running towards a goal post” in a sports video. In some embodiments, the system may implement temporal action segmentation to break action into distinct phases for better accuracy. For example, using this technique, the system may segment a basketball dunk into running, jumping, and scoring using a hierarchical temporal convolution network (HTCN). In some embodiments, the system may implement social interactions and group behavior analysis to enhance video searches by modeling how individual actions relate to group behavior using relation graph networks (RGNs). In some embodiments, the system may implement action energy modeling to model the “energy” of a movement for more nuanced search capabilities. For example, the system may use optical flow to track the intensity or dynamics of detected actions. In some embodiments, the system may implement multimodal feature fusion to improve the accuracy and relevance of results by integrating and analyzing both audio and visual data simultaneously. For example, the system may use audio-visual transformers for multimodal feature fusion.

In some embodiments, at 130, video generator 118 may query a video database 124 based on the detected action. In some embodiments, the video database or portions thereof, may be stored on a local server, an external server (e.g., 1204 of FIG. 12), a cloud server, user equipment (e.g., 1206, 1207, 1208, and 1210 of FIG. 12), a storage device (e.g., CDs, DVDs, Blu-rays, and USB drives, flash drives, NVMe, and NAS), supplemental device, and/or any other suitable device or computing device, or any combination thereof (e.g., the video database 124 may be internal or external to video generator 118). In some embodiments, the video database may be a portion of a larger database, an aggregation of multiple databases, a user's database, or a particular album, channel, source, etc. In some embodiments, the video database or portions thereof may be associated with streaming platforms (e.g., YouTube®, Netflix®, etc.), file-sharing or storage platforms, media applications, or other media content providers.

In some embodiments, the system may generate or encode action embeddings for videos of the video database 124 at the time of the query. In some embodiments, the system may calculate similarity scores until the system identifies a particular number of second videos (e.g., a first subset) having an action similarity score above a threshold. For example, the system may calculate similarity scores until a first subset of videos is identified including ten videos with 75% or greater similarity, or until a first subset of videos is identified including two videos with 90% or greater similarity. In some embodiments, the system may use filtering of the video database to reduce the number of videos for which it may generate or encode action embeddings. For example, videos may be filtered based on content type, content category, duration, resolution/quality, metadata (e.g., keywords or tags), channel/creator/user, language, region, video overall popularity, video virality (e.g., user rating, number of views, number of comments, or number of shares, etc.), date of the video, and/or the user's previous interactions with or creation of the video. For example, filtering may be automatic, configurable, or manually selected/adjusted per search. In some embodiments, the video database 124 may include stored action embeddings of one or more videos, and the system may proceed directly to calculating an action similarity score. In some embodiments, the system may identify a first subset of videos from a video database based on the extracted action embedding of received video 102. For example, video generator 118 may establish a similarity function to compare action embeddings between a portion (e.g., segment) of received video 102 containing the action and a portion of another video containing the action. In some embodiments, video generator 118 may calculate an action similarity score, using action embeddings of matching one or more action segments, for one or more videos of the video database 124. In some embodiments, video generator 118 may identify a first subset of videos based on the action similarity score of the videos of the video database being higher than a predetermined action score threshold (e.g., greater than 60% match). In some embodiments, video generator 118 may identify a first subset of videos based on selecting the videos with the highest action similarity scores.

In some embodiments, at 132, video generator 118 may refine the search by querying the first subset based on the detected pose. In some embodiments, the system may generate or compute pose embeddings for one or more videos of the first subset at this step. In some embodiments, video database 124 may include stored pose embeddings for one or more videos, and the system may proceed directly to calculating a pose similarity score. In some embodiments, the system may establish a similarity function to compare pose embeddings between a portion (e.g., segment) of the first video containing the pose and a portion of a second video containing the pose. In some embodiments, the system may calculate a pose similarity score, using pose embeddings of matching pose segments, for one or more videos of the first subset of videos. In some embodiments, the system may identify a second subset of videos, of the first subset of videos, based on the pose similarity score of a second video being higher than a predetermined pose score threshold (e.g., greater than 60% match). In some embodiments, the system may identify a second subset of videos, of the first subset of videos, based on selecting the videos with the highest pose similarity scores.

In some embodiments, video generator 118 may adjust the weighting of skeletal joints based on the intensity of the movement of a particular joint or set of joints. For example, the system may use a similarity function that considers the motion of the skeletal joints in a video sequence (e.g., via optical flow vectors), to weight joints more heavily where motion intensity is high and less heavily where motion intensity is low. For example, in a scene of a person breaking a brick with their fist, the system may weight the joints associated with the hand hitting the brick more heavily than the hand that has limited movement in the similarity function. For example, if the important part of an action has the most movement, the system may identify videos more efficiently.

In some embodiments, e.g., at 134, video generator 118 may return videos from the subset of videos determined, e.g., in step 132, for user selection. For example, video generator 118 may generate and display a list of the second subset of videos 106-112 for selection. In some embodiments, video generator 118 may order the list based on the similarity score. For example, the video with the highest similarity score would be listed first. In some embodiments, in addition to the similarity score, video generator 118 may order the list based on video overall popularity, video virality (e.g., number of views, number of comments, number of shares, etc.), the recency of the creation of the video, and/or the user's previous interactions with or creation of the video. In some embodiments, video generator 118 may analyze and match the color palette of video segments of the received video 102 to create a visually cohesive split-screen video. In some embodiments, video generator 118 may analyze and contrast the color palette of video segments of the received video 102 to achieve additional creative effects.

In some embodiments, at 136, video generator 118 may generate and display a composite split-screen video of the received video 102 and the selected video 108 on user device 101. In some embodiments, the system may automatically generate the composite video based on the system selecting the result with the greatest similarity score, selecting the most popular (or viral) video result, selecting a video if it is the only result returned, or selecting multiple videos that may be dynamically or manually shuffled for display in the composite video. In some embodiments, the split-screen boundary is one (or more) line, shape, polygon, and/or any combination thereof. In some embodiments, the location, size, and/or orientation of the videos and split-screen boundaries may be adjusted, discussed in more detail below. In some embodiments, the video generator 118 may generate a composite split-screen video where the selected video's figure is superimposed in the received video's background (e.g., next to the received video's figure), such that it looks like they are part of the same video. In some embodiments, the video generator 118 may generate a composite split-screen video where one of the selected video's figure or the received video's figure is superimposed (e.g., with a level of transparency) over the other video's figure, such that it shows the matching movements as they overlap.

In some embodiments, video generator 118 may detect that a user has posted (or is ready to post) a video that is a re-creation of a currently viral video and automatically generates a split-screen video that includes both the user's video and the currently viral video. In some embodiments, video generator 118 may generate more than one split-screen video. For example, video generator 118 may generate a split-screen video that includes the user's video, the viral video and a third video with the highest similarity scores with both the first video and the second video. In some embodiments, video generator 118 may reduce the query by first filter by a selection criterion (e.g., current virality or trending rank).

In some embodiments, the system may create a layered composite split-screen video including visual effects for portions of the composite video. For example, visual effects may include glitch, VHS, black & white, or sepia. In some embodiments, the system may apply the effect(s) to all videos for thematic unity, or the system may apply the effect(s) individually for one or more videos in the composite split-screen video.

In some embodiments, video generator 118 may generate a new audio track for the composite split-screen video based on the audio of the first video 102 and second video 108 used to create the composite split-screen video. For example, video generator 118 may use audio of the first video 102 for the composite split-screen video. For example, video generator 118 may use audio of the second video 108 for the composite split-screen video. For example, video generator 118 may generate a spatial audio track to make the sound from the videos in the composite video to appear as if the sound coming from its respective location on the screen (e.g., 102 having audio seeming to come from the top of device 101 and 108 having audio seeming to come from the bottom of device 101), providing an audio experience that matches the visual layout. In some embodiments, video generator 118 may retrieve audio from the currently viral or highest trending video to match to the actions of first video 102 and second video 108.

In some embodiments, video generator 118 may include a specialized 3D video-to-video search. For example, video generator 118 may establish a similarity function that includes 3D video spatiality. In some embodiments, video generator 118 may generate a composite spilt-screen 3D video of the received 3D video and the selected 3D video. For example, video generator 118 may be utilized to rotate, zoom, or adjust the source videos to appear to interact with the other videos in a three-dimensional space.

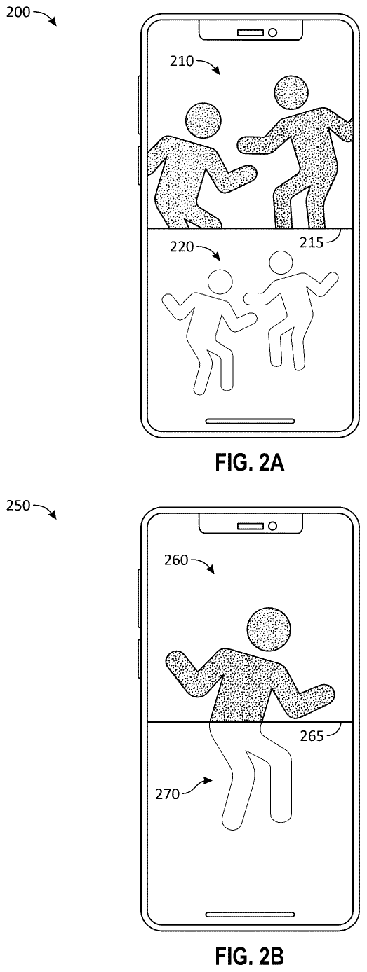

FIGS. 2A and 2B each depict an exemplary schematic illustration of a composite split-screen video, in accordance with some embodiments of the disclosure. In some embodiments, a system may generate a composite video by matching two videos via a two-stage action identification model by first searching for a first subset of videos using a main action and then searching the first subset of videos for a second subset of videos using subclasses of the main action. For example, the system may receive a request (e.g., 104 of FIG. 1), via user device (e.g., 200 of FIG. 2A and 250 of FIG. 2B), to find a match and/or create a composite video for the received video (e.g., 220 of FIG. 2A and 270 of FIG. 2B). The system may follow, e.g., process 800 of FIG. 8 to generate a selection of videos (e.g., 106-112 of FIG. 1).

In some embodiments, the generated composite video may display the received video and the selected video in substantially equally sized display areas. In some embodiments, the system may generate a composite video by arranging the received video (e.g., 220 and 270) and above or below the selected video (e.g., 210 and 260) with a horizontal split-screen boundary (e.g., 215 and 265) in the middle. In some embodiments, system may generate a composite video by arranging the received video to the right or left of the selected video with a vertical split-screen boundary in the middle. In some embodiments, system may generate a composite video with a split-screen boundary in any azimuth of the device display and the received video and selected video on either side. In some embodiments, the system may dynamically adjust the split-screen boundary (e.g., per frame, per action, per pose, etc.). In some embodiments, the system may generate a split-screen boundary between a first video and a second video to generate a split-screen video (e.g., as displayed on device 250 of FIG. 2B) based on the motion vectors of the skeletal joints (e.g., A-Y of person 702 in FIG. 7) determined in either video. For example, the media platform may detect that the head of the figure in video 260 does not move in the frame of reference and select a portion of video 260 that contains the head of the figure and select a portion of video 270 that does not contain the head of figure in video 270 to generate the split-screen video.

In some embodiments, the system may receive user input to make adjustments to the composite video. For example, the user input may be a selection (e.g., a quick touch, tap, or click), an extended selection (e.g., a prolonged touch), a selection and movement (e.g., a prolonged touch with motion), a pinch gesture (e.g., placing two fingers on a touchscreen and moving them together or apart), a rotate gesture (e.g., placing two fingers on a touchscreen and moving them in a circular or twisting motion,), etc. In some embodiments, the system may receive user input in the location of the received video or selected video and the system may exchange the locations of the received video and the selected video or alternate between displaying the received video and selected video at that location. In some embodiments, the system may receive user input in the location of the received video or selected video and the system may rotate the received video or selected video, thus changing the orientation of the video. In some embodiments, the system may receive user input in the location of the received video or selected video and the system may scale the videos larger or smaller. For example, in FIG. 2B, the received video 270 and the selected video 260 may be full-body videos. The system may receive a user input to exchange the location of the received video 270 from the top split-screen area to the bottom split-screen area. The system may receive a user input to enlarge the received video 270 so that only the bottom portion of the body is visible. The system may automatically resize the selected video 260 according to the user input of the received video 270 (or vice versa) or the system may require subsequent user input to alter the selected video 260. In some embodiments, the system may receive user input in the location of the split-screen boundary (e.g., 215 and 265) and the system may move the location of the split-screen boundary, thus changing the proportion of display for the received and selected videos. In some embodiments, the system may receive user input in the location of the split-screen boundary (e.g., 215 and 265) and the system may rotate the split-screen boundary, thus changing the angle of the split areas.

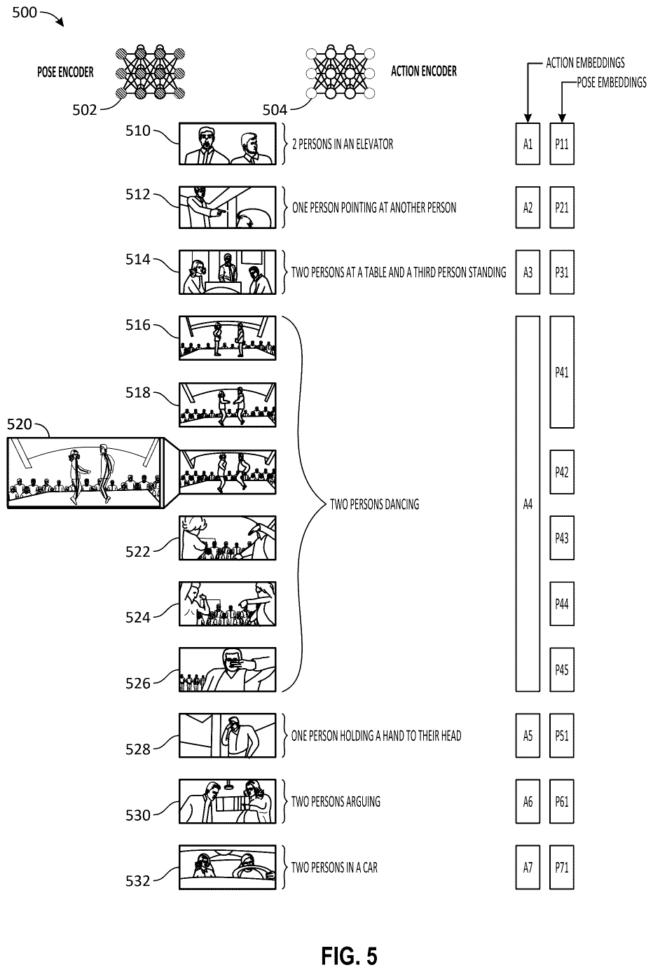

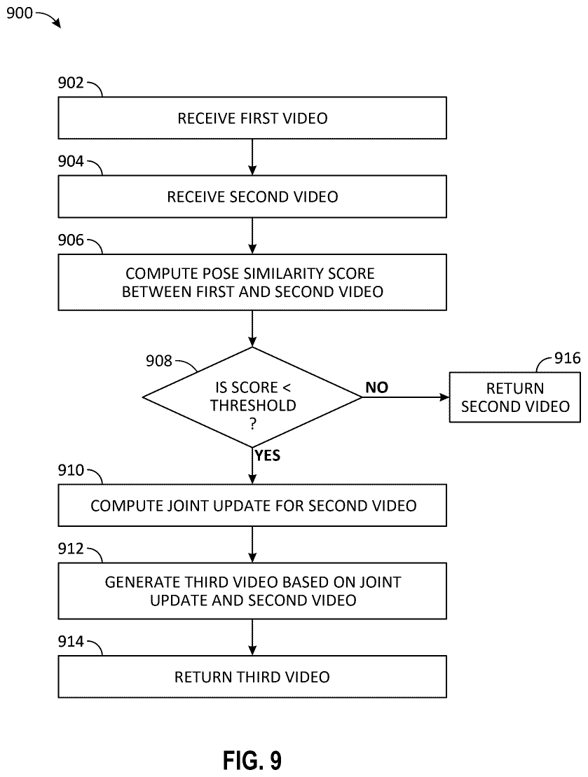

In some embodiments, the system may establish similarity functions to compare embeddings between two video segments. For example, the system may establish a similarity function to compute an action similarity score and identify similar actions based on a comparison of the action embeddings. For example, the system may establish a similarity function to compute a pose similarity score and identify similar individual movements within an action based on a comparison of the pose embeddings. In some embodiments, the system may compare two sets of pose embeddings even if a partial overlap between joint locations is detected (e.g., comparing a full skeletal representation in pose embeddings P41 of FIG. 5 to a partial skeletal representation in pose embeddings P43 of FIG. 5). For example, the system may receive a first video 220 of two dancers performing a dance with a fixed camera angle that includes their full bodies in all frames, thus enabling the system to encode a full skeletal representation of the dancers. The system may receive a second video 210 of two dancers performing a dance with a fixed camera angle that includes only a portion of their bodies in all frames, thus enabling the system to encode a partial skeletal representation of the dancers. In some embodiments, the system may transform or format the pose data of the videos to represent the pose estimation data as coordinates (x, y) and organize this data into a 2D matrix. The system may account for the missing portion of the joints in the first video by copying the values of the corresponding visible joints in the second video's pose matrix and inserting the values into the missing entries or elements of the first video's pose matrix. Once the system has normalized the matrices, the system may use the similarity function to calculate a similarity score (e.g., 906 of FIG. 9). In some embodiments, the system may compare videos or frames where the number of people performing an action in the first video is different than the number of people performing an action in the second video (e.g., comparing frame 524 of FIG. 5 with two figures and frame 526 of FIG. 5 with one figure). For example, the system may normalize the pose matrices by determining a primary figure in the first video, having multiple figures, or by averaging the pose matrices of all figures in the first video, having multiple figures.

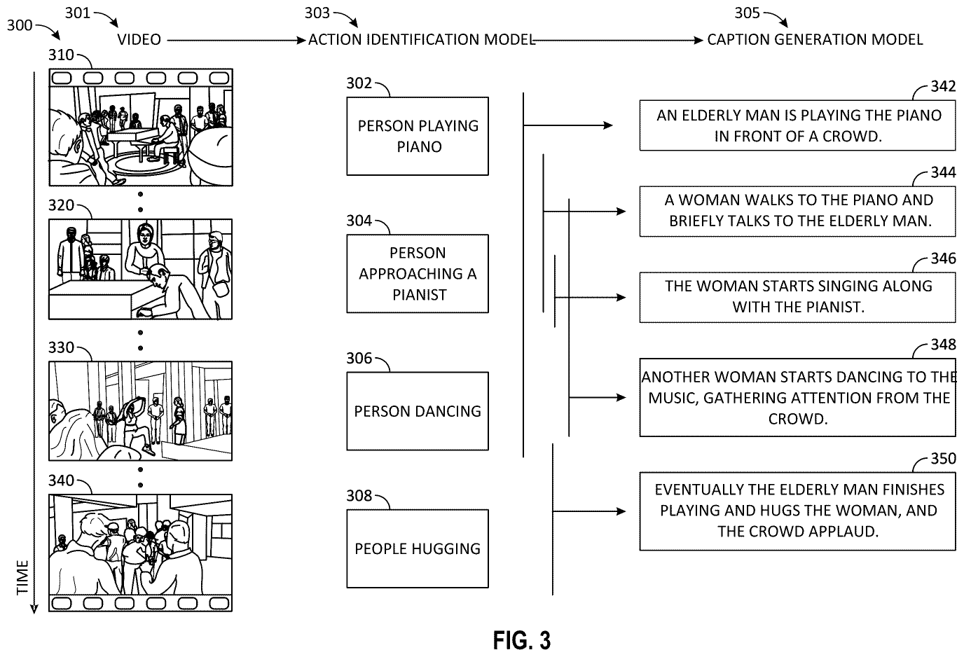

FIG. 3 depicts a schematic illustration of a process 300 for generating action embeddings, in accordance with some embodiments of the disclosure. In some embodiments, the system follows process 300 to identify intermediate action embeddings 302-308 and captions 342-350 of video 301 using an action identification model 303 and a caption generation model 305. For example, the action identification model 303 and caption generation model 305 utilized by the system may include techniques such as spatiotemporal filtering, optical flow, histogram of oriented gradients (HOG), motion history images (MHI), space-time interest points (STIP), bag of visual words (BoVW), transformers, and/or one or more deep learning models (e.g., 2D or 3D convolutional neural network, recurrent neural network, long short-term memory, and graph neural network). The system may input the intermediate action embeddings 302-308 output by the action identification model 303 into the caption generation model 305. For example, the system may use captions 342-350 to conduct a more qualitative similarity search such as to find a second video (e.g., 106-112 of FIG. 1) that has a dramatic scene similar to the scene (e.g., 310-340) in the video 301. In some embodiments, the system only uses an action identification model 303 (e.g., the intermediate action embeddings 302-308 are the action embeddings used for finding a second video based on the actions detected).

In some embodiments, the action embeddings are stored and indexed. For example, the system may attach the generated action embeddings 302-308 to a video program as metadata. In another example, the system may include a data structure comprising indexed timeframe and embeddings information, as shown below:

```
{
  StartTime: 00:00:00
  EndTime: 00:00:32
  ActionEmbeddings: [0.01,0.30,−0.34,−0.97,0.20,0.00,0.05,−0.05,−0.17,0.42,0.66]
  StartTime: 00:00:17
  EndTime: 00:00:23
  ActionEmbeddings: [−0.01,0.30,−0.34,−0.97,0.50,0.70,−0.05,−0.05,−0.17,0.42,0.66]
  StartTime: 00:00:32
  EndTime: 00:00:45
  ActionEmbeddings: [0.82,0.26,0.72, 0.57,−0.32,0.05,−0.08,−0.97,−0.58,0.17,0.26]
}
```

In some embodiments, an action embedding and/or pose embedding may be represented by a vector of rational numbers or a vector of floating point numbers. In other embodiments, the action embedding and/or pose embedding may be represented by a matrix of complex numbers or another mathematical form such as a tensor. Dimensions and structures of the vectors or matrices may differ for action embeddings and pose embeddings. In one example, an action embedding may be a 100×100 square matrix, and a pose embedding may be a 50-component vector.

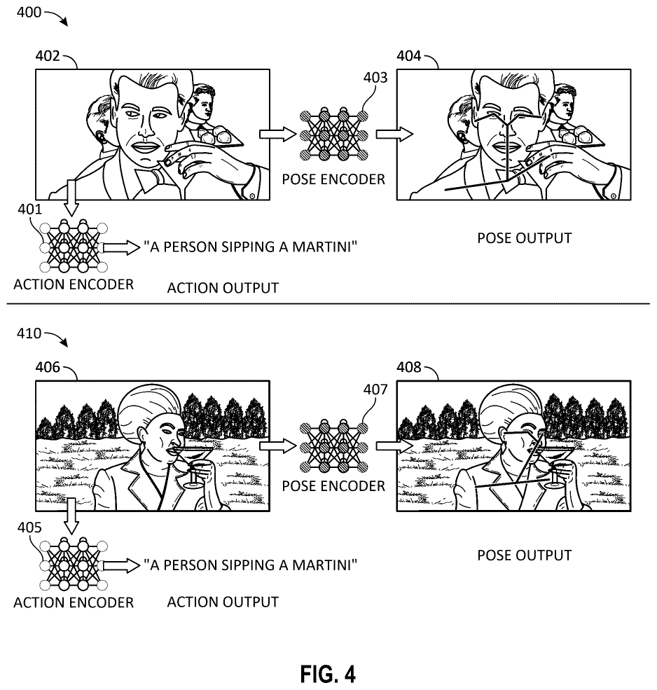

FIG. 4 depicts a schematic illustration of generating action embeddings and pose embeddings, in accordance with some embodiments of the disclosure. For example, scene 400 and scene 410 both represent a person sipping a martini, but have different-gendered persons, in different environments and having different poses. The system may generate or extract action embeddings (e.g., 606 of FIG. 6, 806 of FIG. 8) by using action encoders 401 and 405 (or similarly 120 of FIG. 1, 303 of FIG. 3, and 504 of FIG. 5, for example) on media content 402 and 406 to detect objects, scenes, and actions. For example, the action encoder may detect the form of a person, the form of a martini glass, the motion of the martini glass in relation to the person's hand and mouth, etc. From the analysis of detected objects, scenes, and actions, the system may determine the action embedding output is “a person sipping a martini.” For media content having more than one action detected, the system may segment the video per detected action (e.g., 610 of FIG. 6, 808 of FIG. 8).

In some embodiments, the system may further process the video content by running segments associated with an action embedding through pose encoders 403 and 405 (or similarly 122 of FIG. 1, and 502 of FIG. 5, for example) to generate or compute pose embeddings (e.g., 614 of FIG. 6, 814 of FIG. 8). For example, the pose encoding may be a skeletal reconstruction. For example, the system may compute pose estimation that can be visualized by skeletal joints in scenes 404 and 408. In some embodiments, pose embeddings include a full set of joints or a partial set of joints.

In some embodiments, the pose embeddings are stored and indexed with the action embedding in a nested structure. For example, the system may attach the generated action embeddings and pose embeddings to a video program as metadata. In another example, the system may include a data structure that contains indexed timeframe and embeddings information, as shown below:

```
{
  StartTime: 00:00:00
  EndTime: 00:00:32
  ActionEmbeddings: [0.01,0.30,−0.34,−0.97,0.20,0.00,0.05,−0.05,−0.17,0.42,0.66]
  PoseEmbeddings: {
    StartFrame: 0
    EndFrame: 155
    PoseEmbedding: [0.5,1.2,3.5,5.0,1.1,−2.3,−3.5]
    StartFrame: 156
    EndFrame: 899
    PoseEmbedding: [−0.5,3.2,4.5,1.0,−1.1,0.3,−1.5]
    StartFrame: 900
    EndFrame: 1200
    PoseEmbedding: [1.5,5.0,3.5,5.0,1.1,−2.3,−3.5]
    StartFrame: 1201
    EndFrame: 1920
    PoseEmbedding: [5.0,3.2,3.7,1.0,−1.1,2.3,3.5]
    }
  StartTime: 00:00:17
  EndTime: 00:00:23
  ActionEmbeddings: [−0.01,0.30,−0.34,−0.97,0.50,0.70,−0.05,−0.05,−0.17,0.42,0.66]
  PoseEmbeddings: {
    StartFrame: 0
    EndFrame: 360
    PoseEmbedding: [1.5,5.0,3.5,5.0,1.1,−2.3,−3.5]
    }
  StartTime: 00:00:32
  EndTime: 00:00:45
  ActionEmbeddings: [0.82,0.26,0.72, 0.57,−0.32,0.05,−0.08,−0.97,−0.58,0.17,0.26]
  PoseEmbeddings: {
    StartFrame: 0
    EndFrame: 360
    PoseEmbedding: [0.5,1.2,3.5,5.0,1.1,−2.3,−3.5] StartFrame:361
    EndFrame: 780
    PoseEmbedding: [−0.5,3.2,4.5,1.0,−1.1,0.3,−1.5]
    }
}
```

In some embodiments, an action embedding and/or pose embedding may be represented by a vector of rational numbers or a vector of floating point numbers. In other embodiments, the action embedding and/or pose embedding may be represented by a matrix of complex numbers or another mathematical form such as a tensor. Dimensions and structures of the vectors or matrices may differ for action embeddings and pose embeddings. In one example, an action embedding may be a 100×100 square matrix, and a pose embedding may be a 50-component vector.

FIG. 5 depicts a schematic illustration of pose embeddings nested within action embeddings, in accordance with some embodiments of the disclosure. For example, the media platform may receive media content 500 (e.g., 602 of FIG. 6, 802 of FIG. 8) for a video-to-video search. In some embodiments, the media platform may generate action embeddings A1-A7 (e.g., 606 of FIG. 6, 806 of FIG. 8) by using action encoder 504 (or similarly 120 of FIG. 1, 303 of FIG. 3, and 401 and 405 of FIG. 4, for example) on media content 500. For example, in scene 514, the action encoder may generate the action embedding A3: “Two persons at a table and a third person standing.” The media platform may segment scenes 510-532 per detected actions A1-A7 (e.g., 610 of FIG. 6, 808 of FIG. 8).

In some embodiments, the media platform may further process media content 500 by running action segments A1-A7 through pose encoder 502 (or similarly 122 of FIG. 1, and 403 and 405 of FIG. 4, for example) to generate or compute pose embeddings (e.g., 614 of FIG. 6, 814 of FIG. 8). For example, the pose encoding may be a skeletal reconstruction (e.g., skeletal joints A-Y of person 702). For example, the system may compute pose estimation that can be visualized by skeletal joints in scene 520. For example, pose embeddings may include a full set of skeletal joints or a partial set of skeletal joints. In some embodiments, the system may capture a full skeletal representation in pose embeddings P41 and P42 because frames 516-520 include two people dancing with each of their full bodies visible. In some embodiments, the system may capture a partial skeletal representation in pose embeddings P43 and P44 because frames 522-524 include two people dancing with only a portion of each of their bodies visible. In some embodiments, the media platform may segment the action segments per pose embedding (e.g., 816 of FIG. 8). For example, action embeddings A4 has been segmented into pose embeddings P41-P45.

In some embodiments, the pose embeddings are stored and indexed with the action embedding in a nested structure. For example, the system may attach the generated action embeddings and pose embeddings to a video program as metadata. In another example, the system may include a data structure that contains indexed timeframe and embeddings information, as discussed above.

FIG. 6 depicts a flowchart of a process for generating and storing action and pose embeddings, in accordance with some embodiments of the disclosure. In various embodiments, the individual steps of process 600 may be implemented by one or more components of the devices, systems and methods of FIGS. 1-12 and may be performed in combination with any of the other processes and aspects described herein. Although the present disclosure may describe certain steps of process 600 (and of other processes described herein) as being implemented by certain components of the devices, systems and methods of FIGS. 1-12, this is for purposes of illustration only. It should be understood that other components of the devices, systems and methods of FIGS. 1-12 may implement those steps instead.

In some embodiments, at 602, control circuitry (e.g., 1104 of FIG. 11, and 1211 of FIG. 12), running the media application, may receive or identify a video. In some embodiments, the video is locally stored or generated. For example, the media application may retrieve the video from storage circuitry (e.g., 1108 of FIG. 11, and 1214 of FIG. 12), or the media application may record the video in real time (e.g., through camera 1118 of FIG. 11). In some embodiments, the control circuitry, running the media application, may receive the video from an external source. For example, control circuitry, running the media application, may retrieve the video from a server (e.g., 1204 of FIG. 12), from other user equipment (e.g., 1206, 1207, 1208, and 1210 of FIG. 12), or from a storage device (e.g., CDs, DVDs, Blu-rays, USB drives, flash drives, NVMe, and NAS). In some embodiments, the server may be associated with streaming platforms (e.g., YouTube, Netflix, etc.), file-sharing platforms, media applications, or other media content providers. In some embodiments, the video is transmitted through a communication network (e.g., 1209 of FIG. 12) via a wireless or wired connection (e.g., I/O path 1102 of FIG. 11 and I/O path 1212 of FIG. 12).

In some embodiments, at 604, control circuitry, running the media application, may normalize the video. For example, the media platform may have a default set of characteristics (e.g., resolution, color grading, frame rate, etc.). In another example, the media platform may have a configurable set of characteristics. The configurable characteristics may be determined manually; automatically based on the device running the media platform; automatically based on the server from which the control circuitry, running the media application, has queried; and in any other way by any other suitable source or any combination thereof. In some embodiments, control circuitry, running the media application, may determine that the received video has a first set of characteristics that require normalization. For example, normalization may be required if the first set of characteristics does not match the default characteristics, does not match the configurable characteristics, or does not match a video in a direct comparison of the sets of characteristics. In some embodiments, the media platform may anchor videos by key frames or key poses in the temporal alignment and comparison. For example, the system may allow frames in between the anchored scenes to include variation (or make adjustments for creating the final synced split-screen video). In some embodiments, the media platform may perform normalization when generating a composite video (e.g., a split-screen video) made of two videos. For example, the media platform may adjust the first and/or the second video to avoid unwanted artifacts such as frame drops or inconsistent color grading.

In some embodiments, the media platform may normalize a video using one or more of the following techniques: frame resizing, frame rate normalization, centering and cropping, pixel intensity normalization, mean subtraction, dynamic time warping, body pose normalization, optical flow normalization, histogram equalization, or pose-based normalization. For example, frame resizing may adjust a video's resolution (e.g., 224×224 or 299×299 pixels). For example, frame rate normalization may adjust a video's frame rates (e.g., 15 fps, 30 fps, 60 fps). For example, centering and cropping may remove irrelevant parts of the frame using bounding boxes to localize a key action region, and then the media platform may crop the video to remove the excess or irrelevant background information. For example, pixel intensity normalization may rescale the pixel values of the video frames (e.g., to a range of [0, 1] or [−1, 1]) to ensure uniform brightness and contrast levels across frames. For example, mean subtraction may adjust the video by subtracting the mean pixel value of each frame or the entire video sequence (per channel: R, G, B) to center the data around zero, thereby reducing the effect of varying lighting conditions or overall brightness differences. For example, dynamic time warping may align two video sequences, even if they occur at different speeds, thus ensuring that actions occurring at different speeds are synchronized. For example, body pose normalization may align the human subject in each frame to a canonical pose or orientation to minimize the effects of varying viewing angles and body orientations. For example, optical flow normalization may rescale or smooth optical flow values of a video to reduce noise from irregular or sudden frame-to-frame movements. For example, histogram equalization may adjust the pixel values of the video based on its intensity histogram to improve the contrast of the video if it has poor lighting or low contrast, making the action more detectable. For example, pose-based normalization may align the joints of the skeleton model generated for the video to a reference posture that scales the video to remove the size differences between subjects, and to normalize the joint coordinates (e.g., matrix 704 of FIG. 7).

In some embodiments, at 606, control circuitry, running the media application, may extract, identify, generate, compute, or otherwise determine action embeddings. For example, the control circuitry, running the media application, may use an action identification model (e.g., 120 of FIG. 1, 303 of FIG. 3, 401 and 405 of FIG. 4, and 504 of FIG. 5) to generate action embeddings. The action identification model may perform using techniques such as spatiotemporal filtering, optical flow, histogram of oriented gradients (HOG), motion history images (MHI), space-time interest points (STIP), bag of visual words (BoVW), transformers, and/or one or more deep learning models (e.g., 2D or 3D convolutional neural network, recurrent neural network, long short-term memory, and graph neural network) to detect actions throughout a video. In some embodiments, the action recognition model may output a representation of the detected action in the form of an action embedding. In another embodiment, action and/or pose embeddings may have been previously extracted, identified, generated, computed, or otherwise determined and are retrieved in this step.

In some embodiments, at 608, control circuitry, running the media application, may store action embeddings. For example, the system may attach the generated action embeddings (e.g., 302-308 of FIG. 3 and A1-A7 of FIG. 5) to a video program as metadata. In another example, the system may include a data structure that contains indexed timeframe and embeddings information, as discussed herein. The data structure may be part of or linked to a database. The database, or portions thereof, may be stored on a local server, an external server, a cloud server, the fixed device, supplemental devices, and/or any other suitable devices or computing devices, or any combination thereof. In some embodiments, an action embedding and/or pose embedding may be represented by a vector of rational numbers or a vector of floating point numbers. In other embodiments, the action embedding and/or pose embedding may be represented by a matrix of complex numbers or another mathematical form such as a tensor. Dimensions and structures of the vectors or matrices may differ for action embeddings and pose embeddings. In one example, an action embedding may be a 100×100 square matrix, and a pose embedding may be a 50-component vector.

In some embodiments, at 610, control circuitry, running the media application, may segment video per action detected. For example, the action recognition model (e.g., 120 of FIG. 1, 303 of FIG. 3, 401 and 405 of FIG. 4, and 504 of FIG. 5) may detect several actions through the duration of a video (e.g., actions 302-308 of FIG. 3 and actions associated with frames 510-532 of FIG. 5). In some embodiments, based on the detected actions, the action recognition model may use temporal action localization to determine start and end times and an action embedding for detected actions (e.g., action embeddings A1-A7 of FIG. 5). For example, in FIG. 5, action embedding A4 has a start time associated with the start of frame 516 and an end time associated with the end of frame 526 for the detected action, “Two persons dancing.” In some embodiments, the system may store start and end times with action embeddings. In some embodiments, the system may store start and end frames with action embeddings.

In some embodiments, at 612, control circuitry, running the media application, may determine whether a next action segment is available. For example, the media application processing video 500 after frame 528 may determine there is a next action segment (e.g., 530) and proceed to step 614. For example, the media application processing video 500 after frame 532 may determine there is not a next action segment and proceed to step 618.

In some embodiments, at 614, control circuitry, running the media application, may extract, identify, generate, compute, or otherwise determine pose embeddings for one or more action segments. For example, the control circuitry, running the media application, may use a pose estimation model (e.g., 122 of FIG. 1, 403 of FIG. 4, and 502 of FIG. 5) to generate or compute pose embeddings. The pose estimation model may perform skeletal reconstruction by performing pose tracking to identify key joints and their connections over time. For example, the pose estimation model may use a deep learning model (e.g., 2D or 3D convolutional neural network, recurrent neural network, long short-term memory, and graph neural network) to extract the underlying bone and joint structure of a person's body from the video frames (e.g., represented by skeletal joints A-Y and connections of person 702 of FIG. 7). In some embodiments, the pose estimation model may include a kinematic model to improve accuracy by limiting joint rotations to realistic ranges. In some embodiments, the pose estimation model may extract features such as joint coordinates, angles between joints, joint motion, etc. In some embodiments, the pose estimation model may transform or format the pose data. For example, the media application may represent the pose estimation data as coordinates (x, y) and organize this data into a 2D matrix (e.g., 704 of FIG. 7). In some embodiments, the pose estimation model may output a representation of the pose data in the form of a pose embedding. In another embodiment, action and/or pose embeddings may have been previously extracted, identified, generated, computed, or otherwise determined and are retrieved in this step.

In some embodiments, at 616, control circuitry, running the media application, may store pose embeddings for a respective action segment. For example, the system may attach the generated pose embeddings (e.g., 404 and 408 of FIG. 4 and P11-P71 of FIG. 5) to a video program as metadata. In another example, the system may include a data structure that contains indexed timeframe and embeddings information, as discussed above. The data structure may be part of or linked to a database. The database, or portions thereof, may be stored on a local server, an external server, a cloud server, the fixed device, supplemental devices, and/or any other suitable devices or computing devices, or any combination thereof. In some embodiments, an action embedding and/or pose embedding may be represented by a vector of rational numbers or a vector of floating point numbers. In other embodiments, the action embedding and/or pose embedding may be represented by a matrix of complex numbers or another mathematical form such as a tensor. Dimensions and structures of the vectors or matrices may differ for action embeddings and pose embeddings. In one example, an action embedding may be a 100×100 square matrix, and a pose embedding may be a 50-component vector.

In some embodiments, at 618, control circuitry (e.g., 1104 of FIG. 11, and 1211 of FIG. 12), running the media application, may index action and pose embeddings.

FIG. 7 depicts a schematic illustration of reformatting pose data for computation, in accordance with some embodiments of the disclosure. For example, the media platform may transform or format the pose data to build an adequate pose similarity function. In some embodiments, the media platform may represent the pose estimation data as coordinates (x, y) and organize this data into a 2D matrix. For example, the media platform may perform skeletal reconstruction to generate skeletal joint data represented by skeletal joints A-Y of person 702. The media platform may represent the skeletal joints A-Y as coordinates (x, y) based at least in part on the 2D area defined by frames of the video in which the skeletal reconstruction was performed. The media platform may transform, organize, or format this data into 2D matrix 704.

In some embodiments, the system can compute temporal differences between two frames and average frames that do not exhibit a variation above a threshold. For example, in FIG. 5, at the beginning of action A4, the system may determine that the two persons dancing have constant movement, resulting in a pose matrix (e.g., 704) averaged over the duration of the sequence including frames 516 and 518. The system generates pose embedding P41 (e.g., pose matrix) to represent these frames. For example, in FIG. 5, at frame 520, the system may determine that the dance has changed and generates a new pose matrix (e.g., for pose embedding P42). In some embodiments, the system may compare two pose matrices by normalizing the two matrices. For example, the normalization may include modifying the matrices to have a constant distance between connected non-deformable joints. This normalization allows the system to compare individuals of varied sizes. In some embodiments, when comparing two matrices, the system may use the values of one matrix to fill missing nodes of the other matrix. This allows the system to compare two videos regardless of whether a full set of joints are present in one or the other video of the comparison (e.g., videos 210 and 220 of FIG. 2A). In some embodiments, the system may compute a distance between each node in both matrices individually and average that distance. For example, the average may be a weighted average where distance between extremities may be given more weight than distance between torsos. In another example, a symmetry operation or transformation may be applied to one of the matrices to account for mirroring effects (e.g., when a video being compared is a video selfie).

FIG. 8 depicts a flowchart of a process for video selection based on action and pose embeddings, in accordance with some embodiments of the disclosure. In various embodiments, the individual steps of process 800 may be implemented by one or more components of the devices, systems and methods of FIG. 1-12 and may be performed in combination with any of the other processes and aspects described herein. Although the present disclosure may describe certain steps of process 800 (and of other processes described herein) as being implemented by certain components of the devices, systems and methods of FIG. 1-12, this is for purposes of illustration only. It should be understood that other components of the devices, systems and methods of FIG. 1-12 may implement those steps instead.

In some embodiments, at 802, control circuitry (e.g., 1104 of FIG. 11, and 1211 of FIG. 12), running the media application, may receive or identify a video. In some embodiments, the video is locally stored or generated. For example, the video may be retrieved from storage circuitry (e.g., 1108 of FIG. 11, and 1214 of FIG. 12), or the media application may record the video in real time (e.g., through camera 1118 of FIG. 11). In some embodiments, the control circuitry, running the media application, may receive the video from an external source. For example, the video may be retrieved from a server (e.g., 1204 of FIG. 12), the video may be retrieved from other user equipment (e.g., 1206, 1207, 1208, and 1210 of FIG. 12), or the video may be retrieved from a storage device (e.g., CDs, DVDs, Blu-rays, USB drives, flash drives, NVMe, and NAS). In some embodiments, the server may be associated with streaming platforms (e.g., YouTube, Netflix, etc.), file-sharing platforms, media applications, or other media content providers. In some embodiments, the video is transmitted through a communication network (e.g., 1209 of FIG. 12) via a wireless or wired connection (e.g., I/O path 1102 of FIG. 11 and I/O path 1212 of FIG. 12).

In some embodiments, at 804, control circuitry, running the media application, may normalize the video. For example, the media platform may have a default set of characteristics (e.g., resolution, color grading, frame rate, etc.). In another example, the media platform may have a configurable set of characteristics. The configurable characteristics may be determined manually; automatically based on the device running the media platform; automatically based on the server from which the control circuitry, running the media application, has queried; and in any other way by any other suitable source or any combination thereof. In some embodiments, control circuitry, running the media application, may determine that the received video has a first set of characteristics that require normalization. For example, normalization may be required if the first set of characteristics does not match the default characteristics, does not match the configurable characteristics, or does not match a video in a direct comparison of the sets of characteristics. In some embodiments, the media platform may anchor videos by key frames or key poses in the temporal alignment and comparison. For example, the system may allow frames in between the anchored scenes to include variation (or make adjustments for creating the final synced split-screen video). In some embodiments, the media platform may perform normalization when generating a composite video (e.g., a split-screen video) made of two videos. For example, the media platform may adjust the first and/or the second video to avoid unwanted artifacts such as frame drops or inconsistent color grading.

In some embodiments, the media platform may normalize a video using one or more of the following techniques: frame resizing, frame rate normalization, centering and cropping, pixel intensity normalization, mean subtraction, dynamic time warping, body pose normalization, optical flow normalization, histogram equalization, or pose-based normalization. For example, frame resizing may adjust a video's resolution (e.g., 224×224 or 299×299 pixels). For example, frame rate normalization may adjust a video's frame rates (e.g., 15 fps, 30 fps, 60 fps). For example, centering and cropping may remove irrelevant parts of the frame using bounding boxes to localize a key action region, and then crop the video to remove the excess or irrelevant background information. For example, pixel intensity normalization may rescale the pixel values of the video frames (e.g., to a range of [0, 1] or [−1, 1]) to ensure uniform brightness and contrast levels across frames. For example, mean subtraction may adjust the video by subtracting the mean pixel value of each frame or the entire video sequence (per channel: R, G, B) to center the data around zero, thereby reducing the effect of varying lighting conditions or overall brightness differences. For example, dynamic time warping may align two video sequences, even if they occur at different speeds, thus ensuring that actions occurring at different speeds are synchronized. For example, body pose normalization may align the human subject in each frame to a canonical pose or orientation to minimize the effects of varying viewing angles and body orientations. For example, optical flow normalization may rescale or smooth optical flow values of a video to reduce noise from irregular or sudden frame-to-frame movements. For example, histogram equalization may adjust the pixel values of the video based on its intensity histogram to improve the contrast of the video if it has poor lighting or low contrast, making the action more detectable. For example, pose-based normalization may align the joints of the skeleton model generated for the video to a reference posture that scales the video to remove the size differences between subjects, and to normalize the joint coordinates (e.g., matrix 704 of FIG. 7).

In some embodiments, at 806, control circuitry, running the media application, may extract, identify, generate, compute or otherwise determine action embeddings. For example, the control circuitry, running the media application, may use an action identification model (e.g., 120 of FIG. 1, 303 of FIG. 3, 401 and 405 of FIG. 4, and 504 of FIG. 5) to generate action embeddings. The action identification model may perform using techniques such as spatiotemporal filtering, optical flow, histogram of oriented gradients (HOG), motion history images (MHI), space-time interest points (STIP), bag of visual words (BoVW), transformers, and/or one or more deep learning models (e.g., 2D or 3D convolutional neural network, recurrent neural network, long short-term memory, and graph neural network) to detect actions throughout a video. The action recognition model may output a representation of the detected action in the form of an action embedding. In another embodiment, action and/or pose embeddings may have been previously extracted, identified, generated, computed, or otherwise determined and are retrieved in this step.

In some embodiments, at 808, control circuitry, running the media application, may segment the video per action detected. For example, the action recognition model (e.g., 120 of FIG. 1, 303 of FIG. 3, 401 and 405 of FIG. 4, and 504 of FIG. 5) may detect several actions through the duration of a video (e.g., actions 302-308 of FIG. 3 and actions associated with frames 510-532 of FIG. 5). In some embodiments, based on the detected actions, the action recognition model may use temporal action localization to determine start and end times and an action embedding for detected actions (e.g., action embeddings A1-A7 of FIG. 5). For example, in FIG. 5 action embedding A4 has a start time associated with the start of frame 516 and an end time associated with the end of frame 526 for the detected action, “Two persons dancing.” In some embodiments, the system may store start and end times with action embeddings. In some embodiments, the system may store start and end frames with action embeddings.

In some embodiments, at 809, control circuitry, running the media application, may select a first action segment and then proceed to step 812.

In some embodiments, at 812, control circuitry, running the media application, may select second videos based on the detected action of an action segment. In some embodiments, the system may generate action embeddings for each of the videos of the video database (e.g., 124 of FIG. 1) at this step. In some embodiments, the video database (e.g., 124 of FIG. 1) may include stored action embeddings for one or more videos and the system may proceed to calculate an action similarity score. In some embodiments, the control circuitry, running the media application, may establish a similarity function to compare action embeddings between a portion (e.g., segment) of the first video containing the action and a portion of a second video containing a corresponding action. In some embodiments, the control circuitry, running the media application, may calculate at 812 an action similarity score, using action embeddings of matching action segments, for one or more videos in the video database (e.g., 124 of FIG. 1). In some embodiments, the control circuitry, running the media application, may identify a first subset of videos based on the action similarity score of the video of the video database being higher than a predetermined action score threshold (e.g., greater than 60% match). In some embodiments, the control circuitry, running the media application, may identify a first subset of videos based on selecting the videos with the highest action similarity scores.

In some embodiments, at 814, control circuitry, running the media application, may extract, identify, generate, compute, or otherwise determine pose embeddings of a given action segment. For example, the control circuitry, running the media application, may use a pose estimation model (e.g., 122 of FIG. 1, 403 of FIG. 4, and 502 of FIG. 5) to generate or compute pose embeddings. The pose estimation model may perform skeletal reconstruction by performing pose tracking to identify key joints and their connections over time. For example, the pose estimation model may use a deep learning model (e.g., 2D or 3D convolutional neural network, recurrent neural network, long short-term memory, and graph neural network) to extract the underlying bone and joint structure of a person's body from the video frames (e.g., represented by skeletal joints A-Y and connections of person 702 of FIG. 7). In some embodiments, the pose estimation model may include a kinematic model to improve accuracy by limiting joint rotations to realistic ranges. In some embodiments, the pose estimation model may extract features such as joint coordinates, angles between joints, joint motion, etc. In some embodiments, the pose estimation model may transform or format the pose data. For example, the media application may represent the pose estimation data as coordinates (x, y) and organize this data into a 2D matrix (e.g., 704 of FIG. 7). In some embodiments, the pose estimation model may output a representation of the pose data in the form of a pose embedding. In another embodiment, action and/or pose embeddings may have been previously extracted, identified, generated, computed, or otherwise determined and are retrieved in this step.

In some embodiments, at 816, control circuitry, running the media application, may segment the action segment per pose detected. For example, the pose estimation model (e.g., 122 of FIG. 1, 403 and 407 of FIG. 4, and 502 of FIG. 5) may detect several poses through the duration of an action segment (e.g., poses associated with pose embedding P41-P45 for action associated with action embedding A4 of FIG. 5). In some embodiments, based on the detected poses, the pose estimation model may use a threshold joint movement (e.g., 10% of range) or pose similarity calculation to determine pose transition points. For example, the pose estimation model may use these transition points to mark the start and end of a segment (e.g., segmentation represented by pose embeddings P11-P71 of FIG. 5). In some embodiments, for example, in FIG. 5, pose embedding P41 has a start time associated with the start of frame 516 and an end time associated with the end of frame 518 for the detected pose. In some embodiments, the system may store start and end times with pose embeddings. In some embodiments, the system may store start and end frames with pose embeddings.

In some embodiments, at 818, control circuitry, running the media application, may select third videos from the second videos based on pose embeddings of the action segment. In some embodiments, the control circuitry, running the media application, may extract, identify, generate, compute, or otherwise determine pose embeddings for the videos of the first subset at this step. In some embodiments, the video database (e.g., 124 of FIG. 1) may include stored pose embeddings for one or more videos, and the system may proceed directly to calculating a pose similarity score using a pose similarity function. In some embodiments, the control circuitry, running the media application, may establish a similarity function to compare pose embeddings between a portion (e.g., segment) of the first video containing the pose and a portion of a second video (of the first subset) containing a corresponding pose. In some embodiments, the control circuitry, running the media application, may calculate a pose similarity score, using pose embeddings of matching pose segments, for one or more videos of the first subset of videos. In some embodiments, the control circuitry, running the media application, may identify a second subset of videos, of the first subset of videos, based on the pose similarity score of a second video being higher than a predetermined pose score threshold (e.g., greater than 60% match). For example, the pose score threshold may be manually adjustable by the user, or dynamically adjusted by the control circuitry (e.g., based on the scores of the results, the threshold may be the top 10%, top quartile, above average, etc.). In some embodiments, the control circuitry, running the media application, may identify a second subset of videos, of the first subset of videos, based on selecting the videos with the highest pose similarity scores.

In some embodiments, the control circuitry, running the media application, may adjust the weighting of skeletal joints based on the intensity of the movement of a particular joint or set of joints. For example, weighting may be used when calculating a pose similarity score. For example, the control circuitry, running the media application, may use a motion similarity function that considers the motion of the skeletal joints in a video sequence (e.g., via optical flow vectors), to weight joints more heavily where motion intensity is high and less heavily where motion intensity is low. For example, in a scene of a person breaking a brick with their fist, the control circuitry, running the media application, may weight the joints associated with the hand hitting the brick more heavily than the hand that has limited movement in the similarity function. For example, if the important part of an action has the most movement, the control circuitry, running the media application, may identify videos more efficiently.

In some embodiments, at 820, control circuitry, running the media application, may determine whether a next pose segment is available. For example, the media application processing video 500 after pose embedding P43 may determine there is a next pose segment (e.g., P44) and return to step 818. For example, the media application processing video 500 after pose embedding P4 may determine there is not a next pose segment and proceed to step 810.

In some embodiments, at 810, control circuitry, running the media application, may determine whether a next action segment is available. For example, the media application processing video 500 after frame 528 may determine there is a next action segment (e.g., 530) and proceed to step 812. For example, the media application processing video 500 after frame 532 may determine there is not a next action segment and proceed to step 822.

In some embodiments, at 822, control circuitry, running the media application, may return third videos. For example, the control circuitry, running the media application, may generate and display a list of the second subset of videos for selection (e.g., 106-112 of FIG. 1). In some embodiments, the control circuitry, running the media application, may order or rank the list based on the similarity scores. For example, the video with the highest similarity score would be listed first. In some embodiments, the control circuitry, running the media application, may order the list based on video overall popularity, video virality (e.g., number of views, the number of re-posts or shares, etc.), the recency of the creation of the video, and/or the user's previous interactions with the video.

FIG. 9 depicts a flowchart of a process for video alteration based on pose similarity score, in accordance with some embodiments of the disclosure. In various embodiments, the individual steps of process 900 may be implemented by one or more components of the devices, systems and methods of FIGS. 1-12 and may be performed in combination with any of the other processes and aspects described herein. Although the present disclosure may describe certain steps of process 900 (and of other processes described herein) as being implemented by certain components of the devices, systems and methods of FIGS. 1-12, this is for purposes of illustration only. It should be understood that other components of the devices, systems and methods of FIGS. 1-12 may implement those steps instead.

In some embodiments, at 902 and 904, control circuitry (e.g., 1104 of FIG. 11, and 1211 of FIG. 12), running the media application, may receive a first and second video, respectively. These steps may occur in sequence or in parallel. In some embodiments, the videos are locally stored or generated. For example, either or both videos may be retrieved from storage (e.g., 1108 of FIG. 11, and 1214 of FIG. 12), or the media application may record either or both videos (e.g., through camera 1118 of FIG. 11). In some embodiments, the control circuitry, running the media application, may receive either or both videos from an external source. For example, either or both videos may be retrieved from a server (e.g., 1204 of FIG. 12), either or both videos may be retrieved from other user equipment (e.g., 1206, 1207, 1208, and 1210 of FIG. 12), or either or both videos may be retrieved from a storage device (e.g., CDs, DVDs, Blu-rays, USB drives, flash drives, NVMe, and NAS). In some embodiments, the server may be associated with streaming platforms (e.g., YouTube, Netflix, etc.), file-sharing platforms, media applications, or other media content providers. In some embodiments, either or both videos are transmitted through a communication network (e.g., 1209 of FIG. 12) via a wireless or wired connection (e.g., I/O path 1102 of FIG. 11 and I/O path 1212 of FIG. 12).

In some embodiments, at 906, control circuitry, running the media application, may compute pose similarity score between first and second video. In some embodiments, the control circuitry, running the media application, may establish a similarity function to compare pose embeddings between a portion (e.g., segment) of the first video containing the pose and a portion of the second video containing the pose. In some embodiments, the control circuitry, running the media application, may calculate a pose similarity score, using pose embeddings of matching pose segments.

In some embodiments, at 908, control circuitry, running the media application, may determine whether the pose similarity score is greater than or less than a threshold. In some embodiments, this threshold may be the same as or different from the pose score threshold for selecting a subset of videos. For example, the pose score threshold may be a preconfigured value (e.g., greater than 80% match), manually adjustable by the user, or dynamically adjusted by the control circuitry. For example, if the pose similarity score is less than the threshold, the control circuitry, running the media application, may proceed to step 910. For example, if the pose similarity score is greater than the threshold, the control circuitry, running the media application, may proceed to step 916.

In some embodiments, at 910, control circuitry, running the media application, may compute or determine a joint update for the second video to increase the similarity score. For example, the control circuitry, running the media application, may use reverse kinematics techniques to determine the differences in the pose matrices between the first video and the second video. The control circuitry, running the media application, may run an optimization process to maximize the similarity function score while minimizing the alteration of the second video and produce an optimized pose matrix (e.g., joint update).

In some embodiments, at 912, control circuitry, running the media application, may generate a third video based on the joint update and the second video. For example, control circuitry, running the media application, may feed the joint update (e.g., optimized pose matrix) for the second video and the second video itself into a video-to-video generative AI model to generate the altered version of the second video (e.g., third video).

In some embodiments, at 914, control circuitry, running the media application, may return the third video. For example, the control circuitry, running the media application, may generate and display the third video within the list of the second subset of videos for selection (e.g., 106-112 of FIG. 1) per step 822 of FIG. 8. In another example, the control circuitry, running the media application, may generate and display the composite split-screen video with the first and third video.

In some embodiments, at 916, control circuitry, running the media application, may return the second video. For example, the control circuitry, running the media application, may generate and display the second video within the list of the second subset of videos for selection (e.g., 106-112 of FIG. 1) per step 822 of FIG. 8. In another example, the control circuitry, running the media application, may generate and display the composite split-screen video with the first and second video.

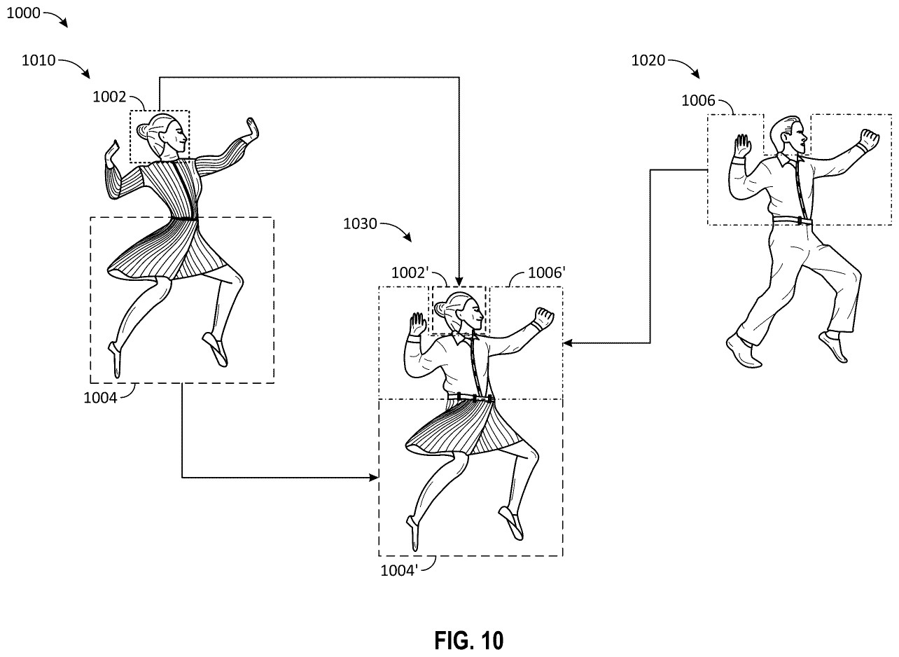

FIG. 10 depicts a schematic illustration of polygonal split-screen video generation, in accordance with some embodiments of the disclosure. In some embodiments, the media platform may generate more than one split-screen boundary. For example, the media platform may cluster skeletal joints (e.g., A-Y of person 702 in FIG. 7) based on their motion vector and location within the frame of reference (e.g., camera perspective, coordinate system, etc.) of the video. The media platform may, based on the clustered skeletal joints, generate polygonal split-screen boundaries of the video. For example, the media platform may generate a split-screen video 1030 from video 1010 and video 1020. In this example, the head 1002 and lower body 1004 of video 1010 and the torso 1006 of video 1020 have been selected to generate the split-screen composite video 1030. The polygonal split-screen boundaries may be visualized by the various dotted lines surrounding clustered joints of head 1002, lower body 1004, and torso 1006. In a non-limiting example, polygonal split-screen boundaries based on clustered joints may include boundaries that encompass a head, arms, hands, legs, torso, upper body, lower body, dextral (right side) body, sinistral (left side) body, or any combination of clustered skeletal joints thereof. All symmetric body parts in the aforementioned non-limiting example may have polygonal split-screen boundaries including only the dextral body part, only the sinistral body part or both dextral and sinistral body parts. In some embodiments, the media platform may also detect the boundaries of the figure's form, and the polygonal split-screen boundaries may closely outline a figure (or figures). For example, the system may be able to remove the background of either or both videos for a more seamless composite video.

In some embodiments, the media platform may receive, via a device graphical user interface, an input to interact with the composite video. For example, the input may be a selection (e.g., a quick touch, tap, or click), an extended selection (e.g., a prolonged touch or hovering over a location), a selection and movement (e.g., a prolonged touch with motion or a click and drag), a pinch gesture (e.g., placing two or more fingers on a touchscreen and moving them together or apart), a rotate gesture (e.g., placing two or more fingers on a touchscreen and moving them in a circular or twisting motion,), etc. In some embodiments, the system may receive a tap at location 1002′ and may switch the currently displayed head of video 1010 to the head of video 1020. In some embodiments, the system may receive an input (e.g., a prolonged touch) at multiple locations to merge or separate the polygonal split-screen boundaries. For example, the media platform may receive a user touch at the location of the arms of torso 1006′ and, in response, generate new polygonal split-screen boundaries to separate the arms from the torso. In another example, the media platform may receive a user touch in the location of the head 1002′ and torso 1006′ and, in response, generate a new polygonal split-screen boundary to merge the head and the torso into one boundary. In some embodiments, the media platform may receive an input to manually adjust the boundary of a polygonal split-screen boundary. For example, the media platform may receive a user prolonged touch with motion, starting at the location of a polygonal split-screen boundary. The media platform may relocate the nodes (or generate additional nodes) based on the motion of the received input. In some embodiments, the media platform may receive an input to manually set the boundary of a polygonal split-screen boundary. For example, the media platform may receive a user tracing at least one area of composite video 1030. For example, the media platform may receive a user selection for preconfigured polygonal split-screen boundaries such as upper body/lower body split, dextral body/sinistral body split, or segments thereof (e.g., head/torso/hips/legs split or left/center/right split). In some embodiments, the system may receive user input in the location of polygonal split-screen section, and the media platform may rotate the section, thus changing the orientation of the section. In some embodiments, the media platform may receive user input in the location of a polygonal split-screen section, and the media platform may relocate the section. For example, media platform may receive a prolonged touch with motion at the location of 1002′, and the media platform may relocate the head 1002′ to the location where the touch is released, thus separating the head 1002′ from torso 1006′. In some embodiments, the system may receive user input in the location of a polygonal split-screen section and the system may scale the video to be larger or smaller within the section boundary or may scale the polygonal split-screen section and the video together to be larger or smaller. For example, the media platform may receive an expanding pinch at the location of head 1002′, and, based on the pinch motion, enlarge the head 1002′ (e.g., like a bobble head). For example, the media platform may receive a tap and an expanding pinch at the location of head 1002′, and based on the pinch motion, enlarge the video within the polygonal split-screen boundary so that only a portion of the head is showing within the polygonal split-screen boundary (e.g., nose, eyes, etc.). The media platform may receive a user input to choose which portion of the video is within view within the polygonal split-screen boundary.

FIGS. 11-12 describe illustrative devices, systems, servers, and related hardware for video-to-video searching and generation of composite split-screen videos, in accordance with some embodiments of the present disclosure. FIG. 11 shows generalized embodiments of illustrative user equipment 1100 and 1101, which may correspond to, e.g., user equipment 101 of FIG. 1; user equipment 200 of FIG. 2A; user equipment 250 of FIG. 2B. For example, user equipment 1100 may be a smartphone device, a tablet, a computer, a near-eye display device, an XR device, or any other suitable device capable of viewing and/or editing media, e.g., locally or over a communication network. In another example, user equipment 1101 may be a user television equipment system or device. User equipment 1101 may include set-top box 1115. Set-top box 1115 may be communicatively connected to microphone 1116, audio output equipment 1114 (e.g., speaker or headphones), and display 1112. In some embodiments, microphone 1116 may receive audio corresponding to a voice of a user and/or ambient audio data. In some embodiments, display 1112 may be a television display, a computer display, a smartphone display, or any display of the aforementioned user equipment. In some embodiments, set-top box 1115 may be communicatively connected to user input interface 1110. In some embodiments, user input interface 1110 may be a remote-control device, sensors that detect user commands, or a touchscreen display. Set-top box 1115 may include one or more circuit boards. In some embodiments, the circuit boards may include control circuitry, processing circuitry, and storage (e.g., RAM, ROM, hard disk, removable disk, etc.). In some embodiments, the circuit boards may include an input/output path (e.g., I/O path 1102). More specific implementations of user equipment are discussed below in connection with FIG. 12. In some embodiments, user equipment 1100 may comprise any suitable number of sensors (e.g., gyroscope or gyrometer, accelerometer, or camera, etc.), and/or a GPS module (e.g., in communication with one or more servers and/or cell towers and/or satellites) to ascertain a location of user equipment 1100. In some embodiments, user equipment 1100 comprises a rechargeable battery that is configured to provide power to the components of the device.

Each one of user equipment 1100 and user equipment 1101 may receive content and data via input/output (I/O) path 1102. I/O path 1102 may provide content (e.g., broadcast programming, on-demand programming, internet content, content available over a local area network (LAN) or wide area network (WAN), and/or other content) and data to control circuitry 1104, which may comprise processing circuitry 1106 and storage circuitry 1108. Control circuitry 1104 may be used to send and receive commands, requests, and other suitable data using I/O path 1102, which may comprise I/O circuitry. I/O path 1102 may connect control circuitry 1104 to one or more communications paths (described below). I/O functions may be provided by one or more of these communications paths but are shown as a single path in FIG. 11 to avoid overcomplicating the drawing. While set-top box 1115 is shown in FIG. 11 for illustration, any suitable computing device having processing circuitry, control circuitry, and storage may be used in accordance with the present disclosure. For example, set-top box 1115 may be replaced by, or complemented by, a personal computer (e.g., a notebook, a laptop, a desktop, user equipment 1207 of FIG. 12), a smartphone (e.g., user equipment 101 of FIG. 1, user equipment 1100, and user equipment 1208 of FIG. 12), a television (e.g., user equipment 1210 of FIG. 12), an XR device (e.g., user equipment 1206 of FIG. 12), a tablet, a network-based server hosting a user-accessible client device, a non-user-owned device, any other suitable device, or any combination thereof.

Control circuitry 1104 may be based on any suitable control circuitry such as processing circuitry 1106. As referred to herein, control circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry may be distributed across multiple separate processors or processing units, for example, multiple of the same type of processing units (e.g., two Intel Core i7 processors) or multiple different processors (e.g., an Intel Core i6 processor and an Intel Core i7 processor). In some embodiments, control circuitry 1104 executes instructions for the media application (as described in connection with FIGS. 1-10) stored in memory (e.g., storage circuitry 1108). Specifically, control circuitry 1104 may be instructed by the media application to perform the functions discussed above and below. In some implementations, processing or actions performed by control circuitry 1104 may be based on instructions received from the media application.

In client/server-based embodiments, control circuitry 1104 may include communications circuitry suitable for communicating with a server or other networks or servers. The media application may be a stand-alone application implemented on a device or a server. The media application may be implemented as software or a set of executable instructions. The instructions for performing any of the embodiments discussed herein of the media application may be encoded on non-transitory computer-readable media (e.g., a hard drive, random-access memory on a DRAM integrated circuit, read-only memory on a BLU-RAY disk, etc.). For example, in FIG. 11, the instructions may be stored in storage circuitry 1108, and executed by control circuitry 1104 of a user equipment 1100.

In some embodiments, the media application may be a client/server application where only the client application resides on user equipment 1100, and a server application resides on an external server (e.g., server 1204 of FIG. 12 and/or media content source 1202 of FIG. 12). For example, the media application may be implemented partially as a client application on control circuitry 1104 of user equipment 1100 and partially on server 1204 as a server application running on control circuitry 1211. Server 1204 may be a part of a local area network with one or more of user equipment 1100, or may be part of a cloud computing environment accessed via the internet. In a cloud computing environment, various types of computing services for performing searches on the internet or informational databases, providing video communication capabilities, providing storage (e.g., for a database) or parsing data are provided by a collection of network-accessible computing and storage resources (e.g., server 1204 and/or an edge computing device), referred to as “the cloud.” User equipment 1100 may be a cloud client that relies on the cloud computing capabilities from server 1204 to generate or encode action and posed embeddings. The client application may instruct control circuitry 1104 to generate video adjustments for better movement matching.

Control circuitry 1104 may include communications circuitry suitable for communicating with a server, edge computing systems and devices, a table or database server, or other networks or servers. The instructions for carrying out the above mentioned functionality may be stored on a server (which is described in more detail in connection with FIG. 12). Communications circuitry may include a cable modem, an integrated services digital network (ISDN) modem, a digital subscriber line (DSL) modem, a telephone modem, an Ethernet card, or a wireless modem for communications with other equipment, or any other suitable communications circuitry. Such communications may involve the internet or any other suitable communication networks or paths (which is described in more detail in connection with FIG. 12). In addition, communications circuitry may include circuitry that enables peer-to-peer communication of user equipment, or communication of user equipment in locations remote from each other (described in more detail below).

Memory may be an electronic storage device provided as storage circuitry 1108 that is part of control circuitry 1104. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVRs, sometimes called personal video recorders, or PVRs), solid state devices, quantum storage devices, gaming consoles, gaming media, or any other suitable fixed or removable storage devices, and/or any combination of the same. Storage circuitry 1108 may be used to store several types of content described herein as well as media application data described above. Nonvolatile memory may also be used (e.g., to launch a boot-up routine and other instructions). Cloud-based storage, described in relation to FIG. 11, may be used to supplement storage circuitry 1108 or instead of storage circuitry 1108. Non-transitory memory may store instructions that, when executed by control circuitry, I/O circuitry, any other suitable circuitry, or combination thereof, executes functions of a media application as described above.

Control circuitry 1104 may include video generating circuitry and tuning circuitry, such as one or more analog tuners, one or more MPEG-2 decoders or HEVC decoders or any other suitable digital decoding circuitry, high-definition tuners, or any other suitable tuning or video circuits or combinations of such circuits. Encoding circuitry (e.g., for converting over-the-air, analog, or digital signals to MPEG or HEVC or any other suitable signals for storage) may also be provided. Control circuitry 1104 may also include scaler circuitry for upconverting and downconverting content into the preferred output format of user equipment 1100. Control circuitry 1104 may also include digital-to-analog converter circuitry and analog-to-digital converter circuitry for converting between digital and analog signals. The tuning and encoding circuitry may be used by user equipment 1100, 1101 to receive and to display, to play, or to record content. The tuning and encoding circuitry may also be used to receive video communication session data. The circuitry described herein, including, for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage circuitry 1108 is provided as a separate device from user equipment 1100, the tuning and encoding circuitry (including multiple tuners) may be associated with storage circuitry 1108.

Control circuitry 1104 may receive instruction from a user by way of user input interface 1110. User input interface 1110 may be any suitable user interface, such as a remote control, mouse, trackball, keypad, keyboard, touch screen, touchpad, stylus input, joystick, voice recognition interface, sensor interface (e.g., to track body movement, eye gaze, biometric parameters, etc.), or other user input interfaces. Display 1112 may be provided as a stand-alone device or integrated with other elements of each one of user equipment 1100 and user equipment 1101. For example, display 1112 may be a touchscreen or touch-sensitive display. In such circumstances, user input interface 1110 may be integrated with or combined with display 1112. In some embodiments, user input interface 1110 includes a remote-control device having one or more microphones, buttons, keypads, sensors, or any other components configured to receive user input or combinations thereof. For example, user input interface 1110 may include a handheld remote-control device having an alphanumeric keypad and option buttons. In a further example, user input interface 1110 may include a handheld remote-control device having a microphone and control circuitry configured to receive and identify voice commands and transmit information to set-top box 1115.

Audio output equipment 1114 may be integrated with or combined with display 1112. Display 1112 may be one or more of a monitor, television, liquid crystal display (LCD) for a mobile device, amorphous silicon display, low-temperature polysilicon display, electronic ink display, electrophoretic display, active matrix display, electro-wetting display, electro-fluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. A video card or graphics card may generate the output to the display 1112. Audio output equipment 1114 may be provided as integrated with other elements of each one of user equipment 1100 and user equipment 1101 or may be stand-alone units. An audio component of videos and other content displayed on display 1112 may be played through speakers (or headphones) of audio output equipment 1114. In some embodiments, audio may be distributed to a receiver (not shown), which processes and outputs the audio via speakers of audio output equipment 1114. In some embodiments, for example, control circuitry 1104 is configured to provide audio cues to a user, or other audio feedback to a user, using speakers of audio output equipment 1114. There may be a separate microphone 1116 or audio output equipment 1114 may include a microphone configured to receive audio input such as voice commands or speech. For example, a user may speak letters or words that are received by the microphone and converted to text by control circuitry 1104. In a further example, a user may voice commands that are received by a microphone and recognized by control circuitry 1104. Camera 1118 may be any suitable video camera integrated with the equipment or externally connected. Camera 1118 may be a digital camera comprising a charge-coupled device (CCD) and/or a complementary metal-oxide semiconductor (CMOS) image sensor. Camera 1118 may be an analog camera that converts to digital images via a video card.

The media application may be implemented using any suitable architecture. For example, it may be a stand-alone application wholly implemented on each one of user equipment 1100 and user equipment 1101. In such an approach, instructions of the application may be stored locally (e.g., in storage circuitry 1108), and data for use by the application is downloaded on a periodic basis (e.g., from an out-of-band feed, from an internet resource, or using another suitable approach). Control circuitry 1104 may retrieve instructions of the application from storage circuitry 1108 and process the instructions to provide video conferencing functionality and generate any of the displays discussed herein. Based on the processed instructions, control circuitry 1104 may determine what action to perform when input is received from user input interface 1110. For example, movement of a cursor on a display up/down may be indicated by the processed instructions when user input interface 1110 indicates that an up/down button was selected. An application and/or any instructions for performing any of the embodiments discussed herein may be encoded on computer-readable media. Computer-readable media includes any media capable of storing data. The computer-readable media may be non-transitory including, but not limited to, volatile and non-volatile computer memory or storage devices such as a hard disk, floppy disk, USB drive, DVD, CD, media card, register memory, processor cache, random access memory (RAM), etc.

Control circuitry 1104 may allow a user to provide user profile information or may automatically compile user profile information. For example, control circuitry 1104 may access and monitor network data, video data, audio data, processing data, content consumption data, and/or any other suitable data being accessed by a user. Control circuitry 1104 may obtain all or part of other user profiles that are related to a particular user (e.g., via social media networks), and/or obtain information about the user from other sources that control circuitry 1104 may access. As a result, a user can be provided with a unified experience across the user's different devices.

In some embodiments, the media application is a client/server-based application. Data for use by a thick or thin client implemented on each one of user equipment 1100 and user equipment 1101 may be retrieved on demand by issuing requests to a server remote to each one of user equipment 1100 and user equipment 1101. For example, the remote server may store the instructions for the application in a storage device. The remote server may process the stored instructions using circuitry (e.g., control circuitry 1104) and generate the displays discussed above and below. The client device may receive the displays generated by the remote server and may display the content of the displays locally on user equipment 1100. This way, the processing of the instructions is performed remotely by the server while the resulting displays (e.g., that may include text, a keyboard, or other visuals) are provided locally on user equipment 1100. User equipment 1100 may receive inputs from the user via user input interface 1110 and transmit those inputs to the remote server for processing and generating the corresponding displays. For example, user equipment 1100 may transmit a communication to the remote server indicating that an up/down button was selected via user input interface 1110. The remote server may process instructions in accordance with that input and generate a display of the application corresponding to the input (e.g., a display that moves a cursor up/down). The generated display is then transmitted to user equipment 1100 for presentation to the user.

In some embodiments, the media application may be downloaded and interpreted or otherwise run by an interpreter or virtual machine (e.g., run by control circuitry 1104). In some embodiments, the media application may be encoded in the ETV Binary Interchange Format (EBIF), received by control circuitry 1104 as part of a suitable feed, and interpreted by a user agent running on control circuitry 1104. For example, the media application may be an EBIF application. In some embodiments, the media application may be defined by a series of JAVA-based files that are received and run by a local virtual machine or other suitable middleware executed by control circuitry 1104. In some of such embodiments (e.g., those employing MPEG-2, MPEG-4, HEVC or any other suitable digital media encoding schemes), the media application may be, for example, encoded and transmitted in an MPEG-2 object carousel with the MPEG audio and video packets of a program.

As shown in FIG. 12, user equipment 1206, 1207, 1208, and 1210 (which may correspond to user equipment 101 of FIG. 1, 200 of FIG. 2A, or 250 of FIG. 2B) may be coupled to communication network 1209. Communication network 1209 may be one or more networks including the internet, a mobile phone network, mobile voice, or data network (e.g., a 5G, 4G, or LTE network), cable network, public switched telephone network, or other types of communication network or combinations of communication networks. Paths (e.g., depicted as arrows connecting the respective devices to the communication network 1209) may separately or together include one or more communications paths, such as a satellite path, a fiber-optic path, a cable path, a path that supports internet communications (e.g., IPTV), free-space connections (e.g., for broadcast or other wireless signals), or any other suitable wired or wireless communications path or combination of such paths. Communications with the client devices may be provided by one or more of these communications paths but are shown as a single path in FIG. 12 to avoid overcomplicating the drawing.

Although communications paths are not drawn between user equipment, these devices may communicate directly with each other via communications paths as well as other short-range, point-to-point communications paths, such as USB cables, IEEE 1394 cables, wireless paths (e.g., Bluetooth, infrared, IEEE 1202-11x, etc.), or other short-range communication via wired or wireless paths. The user equipment may also communicate with each other directly through an indirect path via communication network 1209.

System 1200 may comprise media content source 1202, one or more servers 1204, and/or one or more edge computing devices. In some embodiments, the media application may be executed at one or more of control circuitry 1211 of server 1204 (and/or control circuitry of user equipment 1206, 1207, 1208, 1210 and/or control circuitry of one or more edge computing devices). In some embodiments, the media content source and/or server 1204 may be configured to host or otherwise facilitate video communication sessions between user equipment 1206, 1207, 1208, 1210 and/or any other suitable user equipment, and/or host or otherwise be in communication (e.g., over communication network 1209) with one or more social network services.

In some embodiments, server 1204 may include control circuitry 1211 and storage 1214 (e.g., RAM, ROM, Hard Disk, Removable Disk, etc.). Storage 1214 may store one or more databases. Server 1204 may also include an I/O path 1212. In some embodiments, I/O path 1212 is an I/O circuitry. I/O circuitry may be a NIC card, audio output device, mouse, keyboard card, voice recognition interface, sensor interface, any other suitable I/O circuitry device or combination thereof. I/O path 1212 may provide video conferencing data, device information, or other data, over a local area network (LAN) or wide area network (WAN), and/or other content and data to control circuitry 1211, which may include processing circuitry, and storage 1214. Control circuitry 1211 may be used to send and receive commands, requests, and other suitable data using I/O path 1212, which may comprise I/O circuitry. I/O path 1212 may connect control circuitry 1211 to one or more communications paths.

Control circuitry 1211 may be based on any suitable control circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 1211 may be distributed across multiple separate processors or processing units, for example, multiple of the same type of processing units (e.g., two Intel Core i7 processors) or multiple different processors (e.g., an Intel Core i6 processor and an Intel Core i7 processor). In some embodiments, control circuitry 1211 executes instructions for an emulation system application stored in memory (e.g., the storage 1214). Memory may be an electronic storage device provided as storage 1214 that is part of control circuitry 1211. Memory may store instruction to run the media application.

The processes discussed above are intended to be illustrative and not limiting. One skilled in the art would appreciate that the steps of the processes discussed herein may be omitted, modified, combined and/or rearranged, and any additional steps may be performed without departing from the scope of the invention. More generally, the above disclosure is meant to be illustrative and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, and/or done in parallel. In addition, the systems and methods described herein may be performed in real time. It should also be noted that the systems and/or methods described above may be applied to, or used in accordance with, other systems and/or methods. Throughout the specification the phrases “in response to” and “based on” shall be understood to have a broad meaning unless context requires otherwise. For example, “in response to” can refer to a step that is in direct or indirect response to a prior step, and “based on” can refer to a step that is based at least in part on a prior step.

1. A method comprising:
receiving a first video via a user device;
extracting, from the first video, at least one action embedding;
extracting, from the first video, at least one pose embedding;
identifying a first subset of videos from a video database based at least in part on the extracted at least one action embedding of the first video;
identifying a second subset of videos from the first subset of videos based at least in part on the extracted at least one pose embedding of the first video;
receiving, via a user interface of the user device, selection of a video from the second subset of videos; and
generating for display a composite video comprising at least part of the first video and at least part of the selected video.

2. The method of claim 1, wherein the extracting, from the first video, the at least one action embedding comprises:
normalizing the first video to a set of unique characteristics;
extracting the at least one action embedding from the normalized first video; and
storing the at least one action embedding to a data structure.

3. The method of claim 2, wherein the extracting, from the first video, at least one pose embedding comprises:
segmenting the normalized first video into one or more action segments;
computing the at least one pose embedding for the one or more action segments; and
storing the at least one pose embedding of the one or more action segments to the data structure.

4. The method of claim 1, wherein the composite video comprises a split-screen video displaying at least part of the first video and at least part of the selected video in substantially equally sized display areas.

5. The method of claim 1, wherein the generating for display the composite video comprising the first video and the selected video comprises:
based at least in part on the at least one pose embedding, determining movements of a first portion of the first video that correspond with movements of a second portion of the selected video; and
generating for display the first portion of the first video in a first portion of a display area and the second portion of the selected video in a second portion of the display area.

6. The method of claim 1, wherein the generating for display the composite video comprising the first video and the selected video comprises:
identifying a plurality of skeletal joints of the first video;
for each identified skeletal joint of the plurality of skeletal joints, determining a respective motion vector and a respective location within a frame of reference of the first video;
based at least in part on the determined respective motion vector and the determined respective location, clustering the identified plurality of skeletal joints;
based at least in part on the clustering, generating polygonal split-screen sections for each of the first video and the selected video;
generating for display respective polygonal split-screen sections of the first video and respective polygonal split-screen sections of the selected video distributed within polygonal split-screen sections of a display area.

7. The method of claim 1, further comprising
receiving, via the user interface of the user device, an input identifying a location in a display area;
based at least in part on the input:
a) alternating between a respective split-screen section of the first video and a respective split-screen section of the selected video; or
b) moving the location of a split-screen boundary.

8. The method of claim 1, wherein the identifying the first subset of videos from the video database based at least in part on the extracted at least one action embedding of the first video comprises:
computing an action similarity score between the first video and one or more videos of the video database; and
identifying the first subset of videos based at least in part on the action similarity score of the one or more videos of the video database being higher than a predetermined action score threshold.

9. The method of claim 1, wherein identifying the second subset of videos from the first subset of videos based at least in part on the extracted at least one pose embedding of the first video comprises:
computing a pose similarity score between the first video and videos of the first subset of videos using at least a partial set of skeletal joints; and
identifying the second subset of videos based at least in part on the pose similarity score of the video of the first subset of videos being higher than a predetermined pose score threshold.

10. The method of claim 9, further comprising:
based at least in part on determining that the pose similarity score of the selected video is less than a predetermined pose score threshold:
computing a skeletal joint update for the selected video;
based at least in part on the skeletal joint update, updating the selected video;
providing the updated selected video; and
based at least in part on determining that the pose similarity score is greater than the predetermined pose score threshold;
providing the selected video.

11. A system comprising:
memory;
control circuitry configured to:
store a first video in the memory;
extract, from the first video, at least one action embedding;
extract, from the first video, at least one pose embedding;
identify a first subset of videos from a video database based at least in part on the extracted at least one action embedding of the first video;
identify a second subset of videos from the first subset of videos based at least in part on the extracted at least one pose embedding of the first video;
receive, via a user interface, selection of a video from the second subset of videos; and
cause to provide for display a composite video comprising at least part of the first video and at least part of the selected video.

12. The system of claim 11, wherein the control circuitry configured to extract, from the first video, at least one pose embedding is further configured to:
normalize the first video to a set of unique characteristics;
extract the at least one action embedding from the normalized first video; and
store the at least one action embedding to a data structure.

13. The system of claim 12, wherein the control circuitry configured to extract, from the first video, at least one pose embedding is further configured to:
segment the normalized first video into one or more action segments;
compute the at least one pose embedding for the one or more action segments; and
store the at least one pose embedding of the one or more action segments to the data structure.

14. The system of claim 11, wherein the composite video comprises a split-screen video displaying at least part of the first video and at least part of the selected video in substantially equally sized display areas.

15. The system of claim 11, wherein the control circuitry configured to cause to provide for display a composite video comprising at least part of the first video and at least part of the selected video is further configured to:
based at least in part on the at least one pose embedding, determine movements of a first portion of the first video that correspond with movements of a second portion of the selected video; and
cause to provide for display the first portion of the first video in a first portion of a display area and the second portion of the selected video in a second portion of the display area.

16. The system of claim 11, wherein the control circuitry configured to cause to provide for display a composite video comprising at least part of the first video and at least part of the selected video is further configured to:
identify a plurality of skeletal joints of the first video;
for each identified skeletal joint of the plurality of skeletal joints, determine a respective motion vector and a respective location within a frame of reference of the first video;
based at least in part on the determined respective motion vector and the determined respective location, cluster the identified plurality of skeletal joints;
based at least in part on the clustering, generate polygonal split-screen sections for each of the first video and the selected video;
cause to provide for display respective polygonal split-screen sections of the first video and respective polygonal split-screen sections of the selected video distributed within polygonal split-screen sections of a display area.

17. The system of claim 11, wherein the control circuitry is further configured to:
receive, via the user interface of the user device, an input identifying a location in a display area;
based at least in part on the input:
a) alternate between a respective split-screen section of the first video and a respective split-screen section of the selected video; or
b) move the location of a split-screen boundary.

18. The system of claim 11, wherein control circuitry configured to identify a first subset of videos from a video database based at least in part on the extracted at least one action embedding of the first video is further configured to:
compute an action similarity score between the first video and one or more videos of the video database; and
identify the first subset of videos based at least in part on the action similarity score of the one or more videos of the video database being higher than a predetermined action score threshold.

19. The system of claim 11, wherein the control circuitry configured to identify a second subset of videos from the first subset of videos based at least in part on the extracted at least one pose embedding of the first video is further configured to:
compute a pose similarity score between the first video and videos of the first subset of videos using at least a partial set of skeletal joints; and
identify the second subset of videos based at least in part on the pose similarity score of the video of the first subset of videos being higher than a predetermined pose score threshold.

20. The system of claim 19, wherein the control circuitry is further configured to:
based at least in part on determining that the pose similarity score of the selected video is less than a predetermined pose score threshold:
compute a skeletal joint update for the selected video;
based at least in part on the skeletal joint update, update the selected video;
provide the updated selected video; and
based at least in part on determining that the pose similarity score is greater than the predetermined pose score threshold:
provide the selected video.

21. 50. (canceled)
